(19) United States
(12) Patent Application Publication
(10) Pub. No.: US 2022/0207634 A1
(43) Pub. Date: Jun. 30, 2022

(54) METHOD AND APPARATUS FOR PROBABILISTIC PREDICTION OF AN ATHLETE'S ACCEPTANCE TO AN INSTITUTION

(71) Applicant: Route Analytics Inc., Ashburn, CA (US)

(72) Inventors: Craig RIDLEY, Ashburn, VA (US); Thomas BOOTH, Leesburg, VA (US); Hassan ALI, Crofton, MD (US); Wendell SMITH, Ashburn, VA (US); Tracey RAYBOURN, Fairfax, VA (US); Mark BLOSE, Ashburn, VA (US); Brian CHENG, Arlington, VA (US)

(21) Appl. No.: 17/607,744

(22) PCT Filed: Apr. 29, 2020
(86) PCT No.: PCT/US2020/030541

§ 371 Date: Oct. 29, 2021

Related U.S. Application Data
(60) Provisional application No. 62/840,177, filed on Apr. 29, 2019.

(51) Int. Cl. G06Q 50/20; A63B 24/00

(52) U.S. Cl. CPC G06Q 50/2053; A63B 2220/803; A63B 24/0006

(57) ABSTRACT

An approach is provided for matching a candidate user to an institution based on athletic performance information, athletic observation information, and selection criteria. The approach involves receiving a first data set from a first device associated with a candidate user, wherein the first data set includes athletic performance information. The approach also involves receiving a second data set from a second device associated with a coaching user, wherein the second data set includes athletic observation information associated with the candidate user. The approach further involves determining selection criteria associated with a plurality of institutions for a sports program. The approach also involves matching the candidate user with one or more of the plurality of institutions based on the first data set, the second data set, and the determined selection criteria. The approach further involves initiating presentation of the one or more matching institutions to the first device.

### RELATED APPLICATION

This application claims priority to International Patent Application No. PCT/US2020/030541, filed Apr. 29, 2020, entitled “METHOD AND APPARATUS FOR PROBABILISTIC PREDICTION OF AN ATHLETE'S ACCEPTANCE TO AN INSTITUTION”, which claims priority of U.S. Provisional Patent Application No. 62/840,177, entitled “METHOD AND APPARATUS FOR PROBABILISTIC PREDICTION OF AN ATHLETE'S ACCEPTANCE TO AN INSTITUTION,” filed on Apr. 29, 2019, the contents of which are hereby incorporated herein in their entireties by this reference.

### BACKGROUND

Presently, coaches and recruiters evaluate potential athletes, e.g., high school athletes competing for college athletic scholarships, college athletes competing for a position on a team, amateur athletes competing for jobs as professional athletes, for an optimum combination of desired attributes, e.g., athletic attributes alongside academics, and experience. On the other hand, the potential athletes seek to be recruited by an institution, e.g., college, universities, or professional sports organization, and a coach that is a good fit. Service providers and device manufacturers (e.g., wireless, cellular, etc.) are continually challenged to deliver value and convenience to consumers by, for example, providing solutions that assist the consumers in making a data-driven decision, e.g., recruit finest athletes, select compatible coaches, choose best universities, etc.

### SOME EXAMPLE EMBODIMENTS

Therefore, there is a need for an approach for matching a candidate user, e.g., an athlete, to an institution, e.g., colleges, universities, professional sports organization, based on athletic performance information, athletic observation information, and selection criteria.

According to one embodiment, a method comprises receiving a first data set from a first device associated with a candidate user, wherein the first data set includes athletic performance information. The method also comprises receiving a second data set from a second device associated with a coaching user, wherein the second data set includes athletic observation information associated with the candidate user. The method further comprises determining selection criteria associated with a plurality of institutions for a sports program. The method also comprises matching the candidate user with one or more of the plurality of institutions based on the first data set, the second data set, and the determined selection criteria. The method further comprises initiating presentation of the one or more matching institutions to the first device.

According to one embodiment, a system comprises one or more servers configured to perform: receiving a first data set from a first device associated with a candidate user, wherein the first data set includes athletic performance information. The one or more servers are further configured to comprises receiving a second data set from a second device associated with a coaching user, wherein the second data set includes athletic observation information associated with the candidate user. The one or more servers are further configured to determining selection criteria associated with a plurality of institutions for a sports program. The one or more servers are further configured to matching the candidate user with one or more of the plurality of institutions based on the first data set, the second data set, and the determined selection criteria. The one or more servers are further configured to initiating presentation of the one or more matching institutions to the first device.

According to one embodiment, a method comprises inputting, via a graphical user interface of a device, athletic performance information for a user registered with a service platform for sports program matching. The method also comprises initiating transmission of the athletic performance information to the service platform. The method further comprises receiving institution information specifying one or more institutions that are compatible with the athletic performance information. The method also comprises displaying, via the graphical user interface, the institution information, wherein the graphical user interface includes, a first section for presenting icons representing the one or more institutions, and a second section for presenting menus, buttons, and data entry fields representing general information pertaining to the one or more institutions.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based, at least in part, on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of matching a candidate user to an institution based on athletic performance information, athletic observation information, and selection criteria, according to one example embodiment;

FIG. 2 is a diagram of the components of evaluation platform 109, according to one example embodiment;

FIG. 3 is a flowchart of a process for matching a candidate user with a plurality of institutions, according to one embodiment;

FIG. 4 is a flowchart of a process for displaying a plurality of institutions compatible with the registered user, according to one embodiment;

FIG. 5 is a user interface diagram that represents a log-in screen to access the service, according to one example embodiment;

FIG. 6 is a user interface diagram that represents a sign-up screen for coaches to access a service, according to one example embodiment;

FIG. 7 is a user interface diagram that represents a notification screen alerting a user to select a user type and accept the terms of conditions to access the service, according to one example embodiment;

FIG. 8A is a user interface diagram that represents a sign-up screen for coaches to access the service, according to one example embodiment;

FIG. 8B is a user interface diagram that represents a reference code screen, according to one example embodiment;

FIG. 8C is a user interface diagram that represents a profile/dashboard screen for the coach, according to one example embodiment;

FIG. 8D is a user interface diagram that represents a menu screen for the coach, according to one example embodiment;

FIGS. 8E-8G are user interface diagrams that represent athlete profile data for recruiters, according to one example embodiment;

FIGS. 9A-9E are user interface diagrams that represent sign-up screens for athletes to access the service, according to one example embodiment;

FIG. 10 is a user interface diagram that represents a dashboard for an athlete, according to one example embodiment;

FIG. 11 is a user interface diagram that represents a chart for an athlete, according to one example embodiment;

FIG. 12A is a user interface diagram that represents a dashboard for an athlete, according to one example embodiment;

FIG. 12B is a user interface diagram that represents a graphical user interface displaying institution information, according to one example embodiment;

FIG. 12C is a user interface diagram that represents a webpage of an institution in a graphical user interface of a user device, according to one example embodiment;

FIG. 12D is a user interface diagram that represents a graphical user interface displaying a chart for one or more institutions, according to one example embodiment;

FIG. 13 is a user interface diagram that represents a menu screen for an athlete, according to one example embodiment;

FIG. 14 is a user interface diagram that represents location information of registered users, according to one example embodiment;

FIG. 15A is a user interface diagram that represents a chat forum, according to one example embodiment;

FIG. 15B is a user interface diagram that represents an athlete's profile for sharing, according to one example embodiment;

FIG. 16 is a user interface diagram that represents account information of a registered user, according to one example embodiment;

FIG. 17 is a diagram of hardware that can be used to implement an embodiment;

FIG. 18 is a diagram of a chip set that can be used to implement an embodiment; and

FIG. 19 is a diagram of a mobile terminal (e.g., handset) that can be used to implement an embodiment.

### DESCRIPTION OF SOME EMBODIMENTS

Examples of a method, apparatus, and computer program for matching a candidate user to an institution based on athletic performance information, athletic observation information, and selection criteria are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

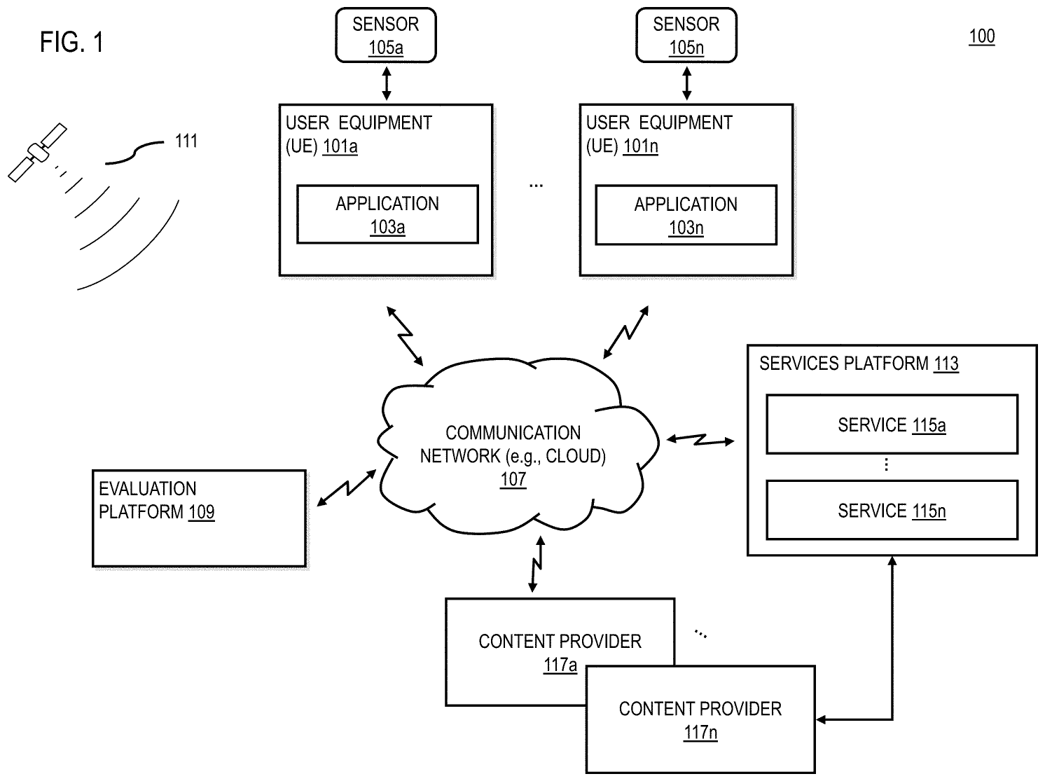

FIG. 1 is a diagram of a system capable of matching a candidate user to an institution based on athletic performance information, athletic observation information, and selection criteria, according to one embodiment. The recruiting process, e.g., recruitment by a college or a professional sports organization, is a long, drawn out, and an overwhelming process in which coaches and recruiters evaluate numerous potential athletes for an optimum combination of desired attributes. The recruiters and coaches often prefer athletes with the best athletic and academic attributes. In contrast, candidates or applicants, e.g., athletes, seeks to find an institution and a coach that will best enhance their talent. However, the recruiters and coaches have an unfair advantage (e.g., with respect to information) over the admission of prospective athletes. Furthermore, the assessment by both recruiters and prospective athletes of each other foregoing attributes are not formed in view of objective criteria because there lacks an efficient process in obtaining and analyzing each other's attributes to reach an informed decision. That is, traditionally, there is no mechanism by which the institutions and the coaches can obtain information regarding the desired attributes of potential athletes, or the potential athletes' accessing information about what the institutions' needs are. Moreover, such information, even if obtainable, has not been objectively evaluated for both the benefit of the athletes and the institutions.

To address this problem, a system 100 of FIG. 1 introduces the capability to match a candidate user to an institution based on athletic performance information, athletic observation information, and selection criteria. In one embodiment, the system 100 receives various data from one or more athletes (or candidates). By way of example, the data can include athletic information, academic information, location information, or a combination thereof. In another embodiment, the system 100 receives quantitative or qualitative data from a plurality of institutions, such quantitative or qualitative data comprises selection criteria, admission information, or a combination thereof; additionally, the plurality of institutions comprise colleges, universities, professional sports organization, or a combination thereof. The system 100 then matches a candidate user (e.g., athlete) to an institution based on athletic performance information, athletic observation information, and selection criteria. The data collection necessary to acquire such data/information can be accomplished, for example, through the use of a single or multiple applications executed on any number of devices, as next explained.

As shown in FIG. 1, the system 100 comprises user equipment (UE) 101a-101n (collectively referred to as UE 101) that is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.). The applications 103 may assist in conveying sensor information and/or the previously described data sets and information via the communication network 107.

By way of example, the applications 103 may be any type of application that is executable at the UE 101, such as content provisioning services, camera/imaging application, media player applications, social networking applications, calendar applications, and the like. In one embodiment, one of the applications 103 at the UE 101 may act as a client for the evaluation platform 109 and perform one or more functions associated with the functions of the evaluation platform 109 by interacting with the evaluation platform 109 over the communication network 107.

By way of example, the sensors 105 may be any type of sensor. In certain embodiments, the sensors 105 may include, for example, a global positioning sensor for gathering location data, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, and the like. In one example embodiment, the UE 101 may include GPS receivers to obtain geographic coordinates from satellites 111 for determining current location and time associated with the UE 101. Further, the location can be determined by a triangulation system such as A-GPS, Cell of Origin, or other location extrapolation technologies.

The communication network 107 of system 100 includes one or more networks such as a data network, a wireless network, a telephony network, or any combination thereof. It is contemplated that the data network may be based on cloud computing technologies, as well as be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the evaluation platform 109 may be a platform with multiple interconnected components. The evaluation platform 109 may include multiple servers, intelligent networking devices, computing devices, components and corresponding software for matching a candidate user to an institution based on athletic performance information, athletic observation information, and selection criteria. In addition, it is noted that the evaluation platform 109 may be a separate entity of the system 100, a part of the one or more services 115a-115n (collectively referred to as services 115) of the services platform 113, or included within the UE 101 (e.g., as part of the applications 103), or included in a calculation system of a fee authority.

In one embodiment, the evaluation platform 109 may receive athletic performance information from candidate users registered with a service platform for sports program matching, e.g., one or more registered athletes. The athletic performance information comprises athletic information, academic information, location information, or a combination thereof. In one example embodiment, athletic information comprises athletic performance data, athletic performance tests, e.g., measuring vertical jump of an athlete, measuring total time to complete an agility shuttle, a kneeling power-ball toss, measuring sprint time of the athlete over a 40-yard distance, or a peak power-vertical jump. In another example embodiment, academic information comprises class rank, grade point average (GPA), number of advanced placement classes completed, scholastic achievement test reading score, scholastic achievement test math score, scholastic achievement test writing score, etc.

In one embodiment, the evaluation platform 109 may receive athletic observation information associated with candidate users from a coaching user registered with a service platform for sports program matching, e.g., coaches. In one embodiment, athletic observation information comprises athletic performance points, physical attribute points, work ethic points, leadership points, teamwork points, compatibility points, etc. from the perspective of a coach. In one example embodiment, a coach may observe a player in terms of their performance, physical attributes, work ethic, etc., before considering the players for recruitment. In another embodiment, the athletic observation information comprises attributes of the candidate user, preferences of the candidate user concerning attributes of the coaching user, preferences of the candidate user concerning attributes of the plurality of institutions, or a combination thereof.

In one embodiment, the evaluation platform 109 may receive quantitative or qualitative data from a plurality of institutions, wherein the quantitative or qualitative data comprises selection criteria, admission information, or a combination thereof. The plurality of institutions comprises colleges, universities, professional sports organizations, or a combination thereof. In one example embodiment, selection criteria comprise average athletic performance test scores, average GPA, average scholastic assessment test (SAT) scores, and average interview performance scores. In another example embodiment, admission information comprises the selectivity level for a sports program or an academic program of an institution, e.g., the selectivity level of an institution can indicate the likelihood of acceptance of the registered users.

In one embodiment, the evaluation platform 109 may match a candidate user to an institution based on athletic performance information, athletic observation information, and selection criteria. In one embodiment, the evaluation platform 109 may compare athletic information, academic information, and location information of a registered user, e.g., an athlete, with the selection criteria and admission information of an institution to determine a probability of acceptance. In one example embodiment, the evaluation platform 109 may compare data of current applicants with previous applicants accepted by the institution. In another example embodiment, the evaluation platform 109 may select at least one institution based on a search radius set by the user, e.g., 200 miles, from his/her location.

The services platform 113 may include any type of service. By way of example, the services platform 113 may include notification services, social networking services, content (e.g., audio, video, images, etc.) provisioning services, application services, storage services, contextual information determination services, location-based services, information (e.g., weather, news, etc.) based services, etc. In one embodiment, the services platform 113 may interact with the UE 101, the evaluation platform 109 and the content provider 117 to supplement or aid in the processing of the content information.

By way of example, the services 115 may be an online service that reflects the interests and/or activities of users. The services 115 allow users to share location information (e.g., speed information), activities information, contextual information, historical user information and interests within their individual networks, and provides for data portability. The services 115 may additionally assist in providing the evaluation platform 109 with activity information for at least one user in at least one location, user profile information, and a variety of additional information.

The content providers 117a-117n (collectively referred to as content provider 117) may provide content to the UE 101, the evaluation platform 109, and the services 115 of the services platform 113. The content provided may be any type of content, such as image content (e.g., pictures), textual content, audio content, video content, etc. In one embodiment, the content provider 117 may provide content that may supplement the content of the applications 103, the sensors 105, or a combination thereof. In one embodiment, the content provider 117 may also store content associated with the UE 101, the evaluation platform 109, and the services 115 of the services platform 113. In another embodiment, the content provider 117 may manage access to a central repository of data and offer a consistent, standard interface to data, such as attributes, probe data, and traffic sign information for one or more locations, which may aid in presenting geolocation information to the candidate users.

By way of example, the UE 101, the evaluation platform 109, the services platform 113, and the content provider 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

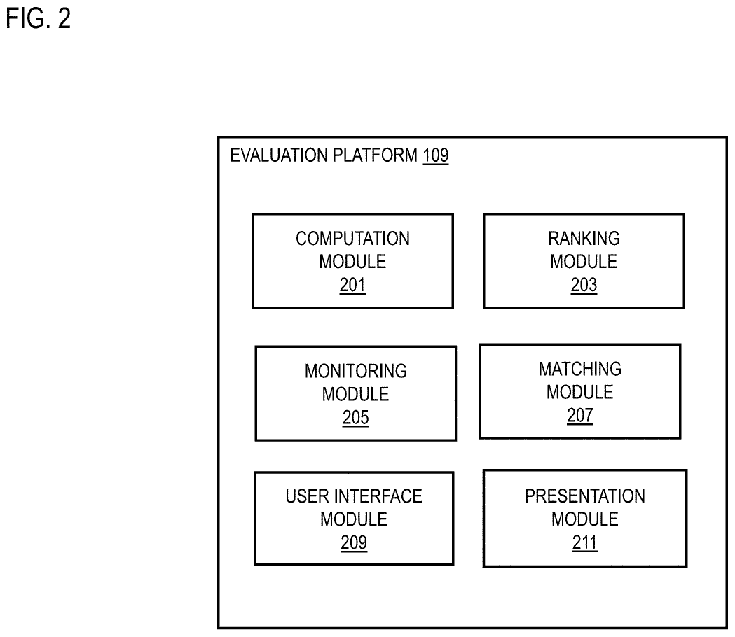

FIG. 2 is a diagram of the components of the evaluation platform 109, according to one embodiment. By way of example, the evaluation platform 109 includes one or more components for matching a candidate user to an institution based on athletic performance information, athletic observation information, and selection criteria. It is contemplated that the functions of these components may be combined in one or more components or performed by other components of equivalent functionality. In this embodiment, the evaluation platform 109 includes a computation module 201, a ranking module 203, a monitoring module 205, a matching module 207, a user interface module 209, and a presentation module 211.

In one embodiment, the computation module 201 may perform data analytics using historical data of the registered users for assisting users in making decisions during a recruitment process. By way of example, data analytics may include analyzing raw data received from registered users and institutions to make an informed decision. In another embodiment, the computation module 201 triggers the execution of the various other modules. It is noted that the data analytics described herein are provided as examples, and are not intended as limitations to the types of data analytics that are applicable to the various embodiments described herein.

In one embodiment, the ranking module 203 may rank one or more registered candidate user, e.g., athletes, based on average athletic performance test scores, average academic scores, location information, or a combination thereof. In another embodiment, the ranking module 203 may rank one or more registered coaching users, e.g., coaches, based on compatibility scores, e.g., a score based on compatibility between coaches and their students, popularity scores, e.g., votes received by coaches from registered users, performance scores, e.g., matches won by the coaches' team, or a combination thereof. In a further embodiment, the ranking module 203 may rank one or more institutions, e.g., universities, colleges, sports organizations, etc., based on popularity scores, e.g., votes received from registered users, user preference information, admission information, selectivity, or a combination thereof.

In one embodiment, the monitoring module 205 may monitor data of registered users in real-time, periodically, according to schedule, on demand, or a combination thereof. The monitoring module 205 may provide the matching module 207 with real-time data of the registered users, whereupon the matching module 207 may cause matching of the registered users, e.g., athletes, with other registered users, e.g., coaches. In another embodiment, the matching module 207 may cause matching of the registered users, e.g., athletes, with institutions, e.g., colleges, universities, professional sports teams.

In one embodiment, the user interface module 209 may generate a user interface element in response to the detection of an input for a presentation of one or more data types. In one embodiment, the user interface module 209 employs various application programming interfaces (APIs) or other function calls corresponding to the application 103 of UE 101; thus enabling the display of graphics primitives such as menus, data entry fields, etc., for generating the user interface elements. Still further, the user interface module 209 may be configured to operate in connection with augmented reality (AR) processing techniques, wherein various different applications, graphic elements, and features may interact.

In one embodiment, the presentation module 211 obtains a set of summary statistics and/or updates from the other modules. Thereafter, the presentation module 211 may present a user interface in a UE 101 and/or at least one website in a UE 101 that allows the user to select at least one service, e.g., creating an athlete profile, creating a coach profile, etc. In one embodiment, the presentation module 211 may present one or more matching institutions in a device associated with the registered users. In another embodiment, the presentation module 211 may generate a presentation of at least one notification in the UE 101 requesting for access credentials from the users. The presentation module 211 may cause a presentation of notification regarding the status of an access request, e.g., granting, rejection, or pending. In a further embodiment, the presentation module 211 may cause a presentation of relevant content information in the most suitable manner upon granting of an access request.

The above presented modules and components of the evaluation platform 109 can be implemented in hardware, firmware, software, or a combination thereof. Though depicted as a separate entity in FIG. 1, it is contemplated that the evaluation platform 109 may be implemented for direct operation by respective UE 101. As such, the evaluation platform 109 may generate direct signal inputs by way of the operating system of the UE 101 for interacting with the applications 103. In another embodiment, one or more of the modules 201-211 may be implemented for operation by respective UEs, as an evaluation platform 109. Still further, the evaluation platform 109 may be integrated for direct operation with the services 115, such as in the form of a widget or applet, in accordance with an information and/or subscriber sharing arrangement. The various executions presented herein contemplate any and all arrangements and models.

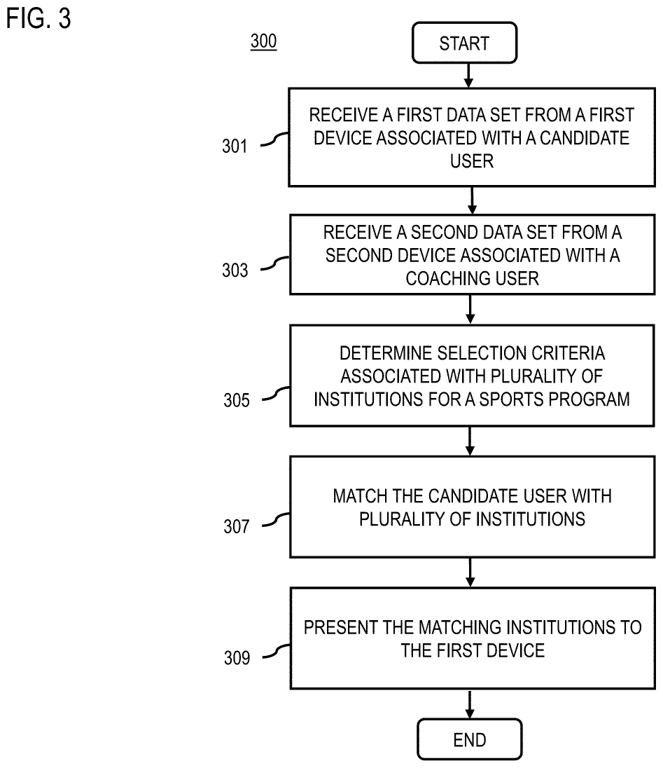

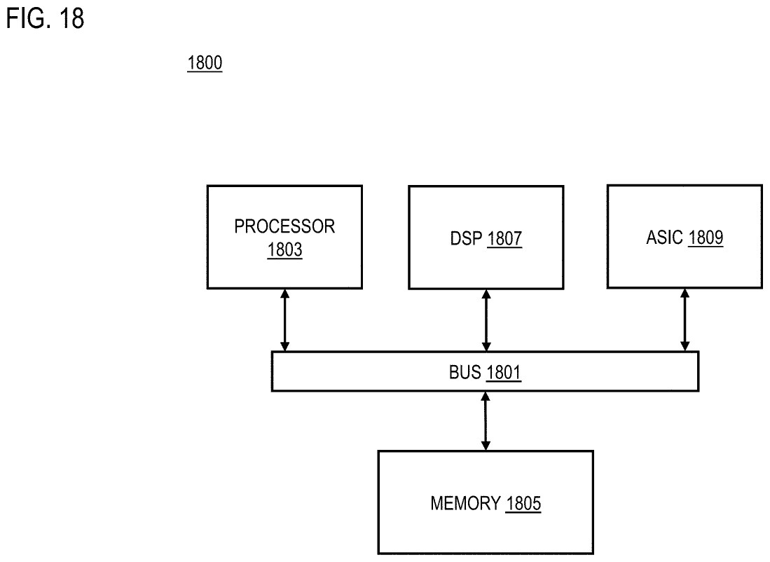

FIG. 3 is a flowchart of a process for matching a candidate user with a plurality of institutions, according to one embodiment. In one embodiment, evaluation platform 109 performs the process 300 and is implemented in, for instance, a chip set including a processor and a memory as shown in FIG. 18.

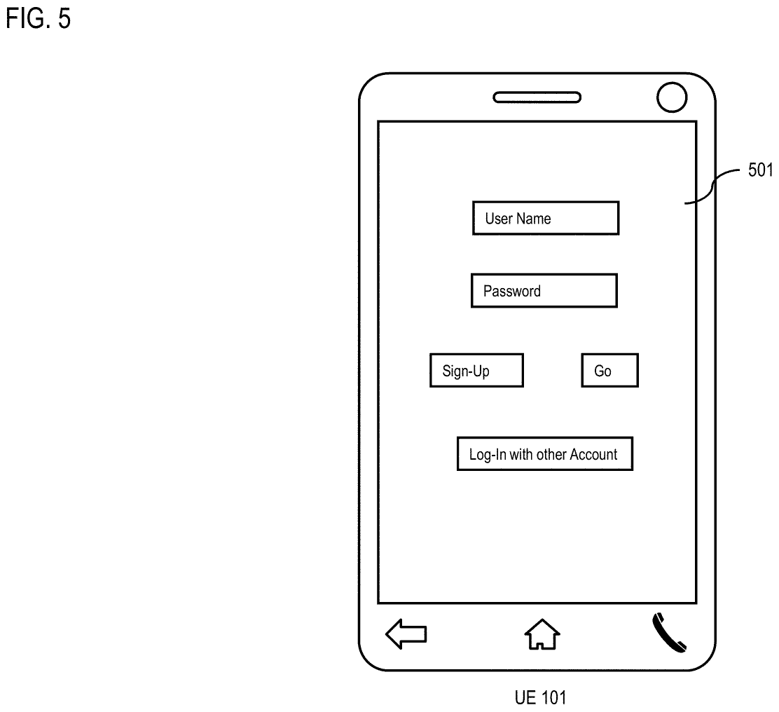

In step 301, evaluation platform 109 receives a first data set from a first device, e.g., UE 101a, associated with a candidate user, e.g., a registered user. In one embodiment, the first data set includes athletic performance information, wherein the athletic performance information comprises athletic performance test results of the overall athletic performance of the candidate user. In another embodiment, the candidate user is among a plurality of candidate users registered to a subscription service, e.g., a sports program matching service, as depicted in FIGS. 5-7 and 9A-9E.

In step 303, evaluation platform 109 receives a second data set from a second device, e.g., UE 101b, associated with a coaching user, e.g., a registered coach. In one embodiment, the second data set includes athletic observation information associated with the candidate user. In one embodiment, the athletic observation information comprises attributes of the candidate user, preferences of the candidate user concerning attributes of the coaching user, preferences of the candidate user concerning attributes of the plurality of institutions, or a combination thereof. In another embodiment, athletic observation information comprises athletic performance points, physical attribute points, work ethic points, leadership points, teamwork points, compatibility points, etc. from the perspective of the coaching user. In one example embodiment, a coach may observe a player in terms of their performance, physical attributes, work ethic, etc., before considering the players for recruitment. In another embodiment, the coaching user is among a plurality of coaching users registered to a subscription service, e.g., a sports program matching service, as illustrated in FIGS. 5-8B. The subscription service is supported by the evaluation platform 109 in conjunction with the services platform 113. In this manner, fees can be charged for subscription to the matching service to the candidate users, the coaching users, and/or the institutions (or organizations).

In step 305, evaluation platform 109 determines selection criteria associated with a plurality of institutions for a sports program. In one embodiment, the selection criteria comprise average athletic performance test scores, average grade point average (GPA), average scholastic assessment test (SAT) scores, average interview performance scores, or a combination thereof required for admissions to the sports program.

In step 307, evaluation platform 109 matches the candidate user, e.g., a registered user, with the plurality of institutions, e.g., university, sports organizations, etc., based on the first data set, the second data set, and the determined selection criteria. In one embodiment, evaluation platform 109 compares the first data set and the second data set associated with the candidate users. Thereafter, evaluation platform 109 ranks the plurality of candidate users based on the comparison. Subsequently, the evaluation platform 109 ranks the plurality of institutions based on the selection criteria. Then, the evaluation platform 109 calculates a probability of acceptance of the candidate user by at least one institution from the plurality of institutions based on the rankings. In another embodiment, the evaluation platform 109 determines the compatibility level between the candidate user and the coaching user based on the first data set and the second data set. Thereafter, evaluation platform 109 matches the candidate user and the coaching user based on the compatibility level. In one example embodiment, the coaching users are associated, e.g., employees, with the plurality of institutions. In a further embodiment, evaluation platform 109 determines location information of the candidate user. Then, evaluation platform 109 matches the coaching user, the plurality of institutions, or a combination thereof to the candidate user based on proximity to the location information.

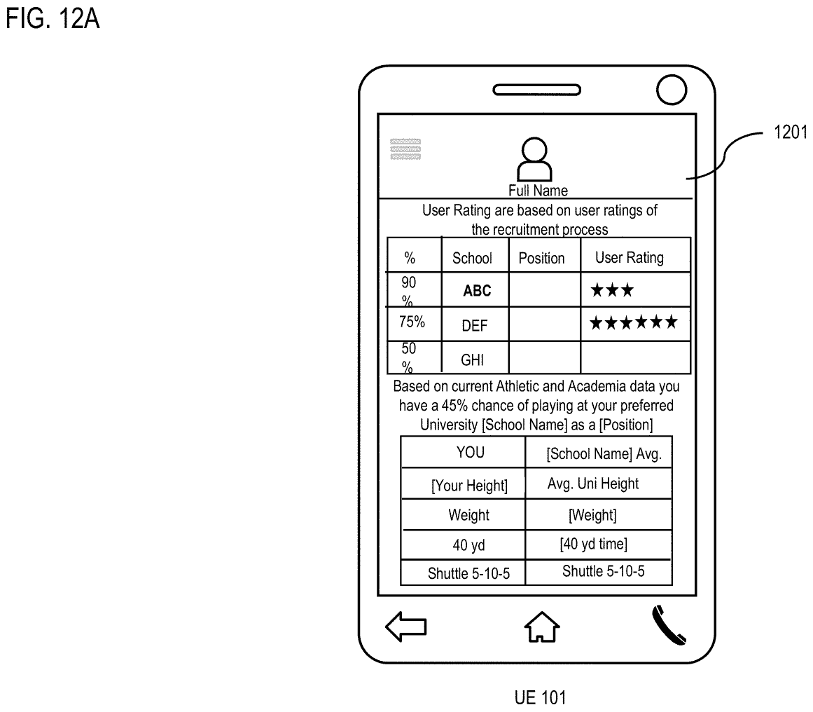

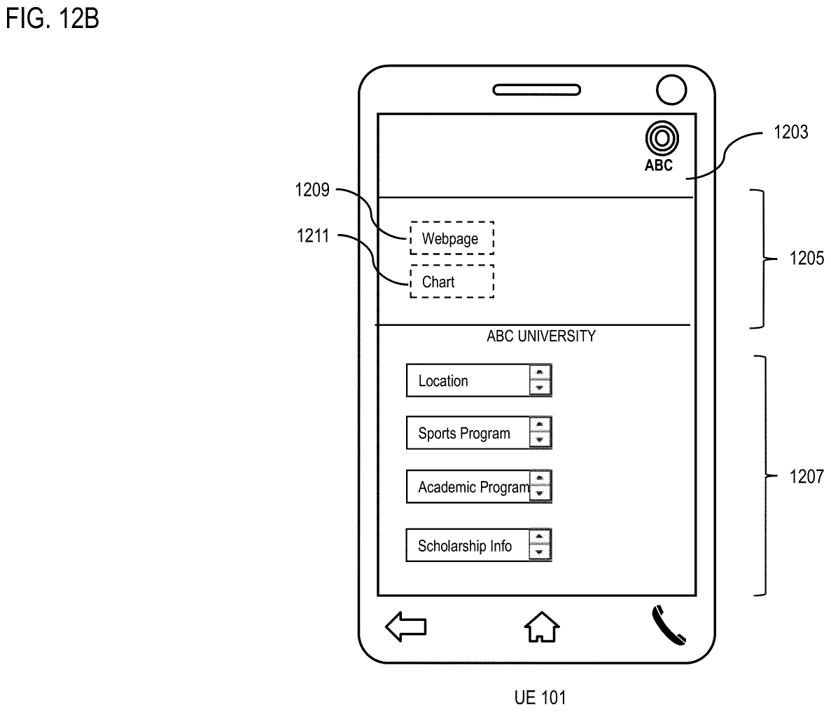

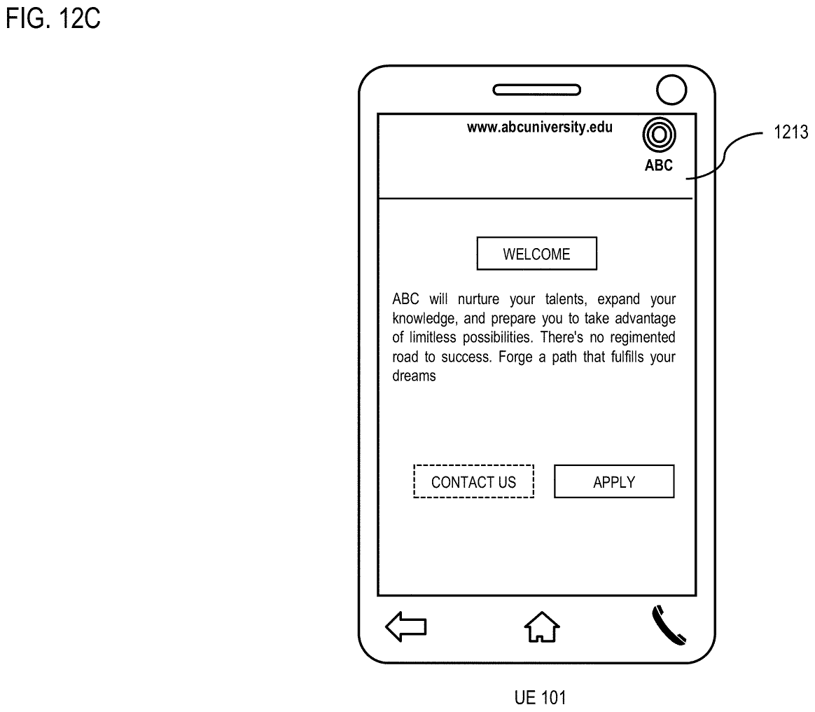

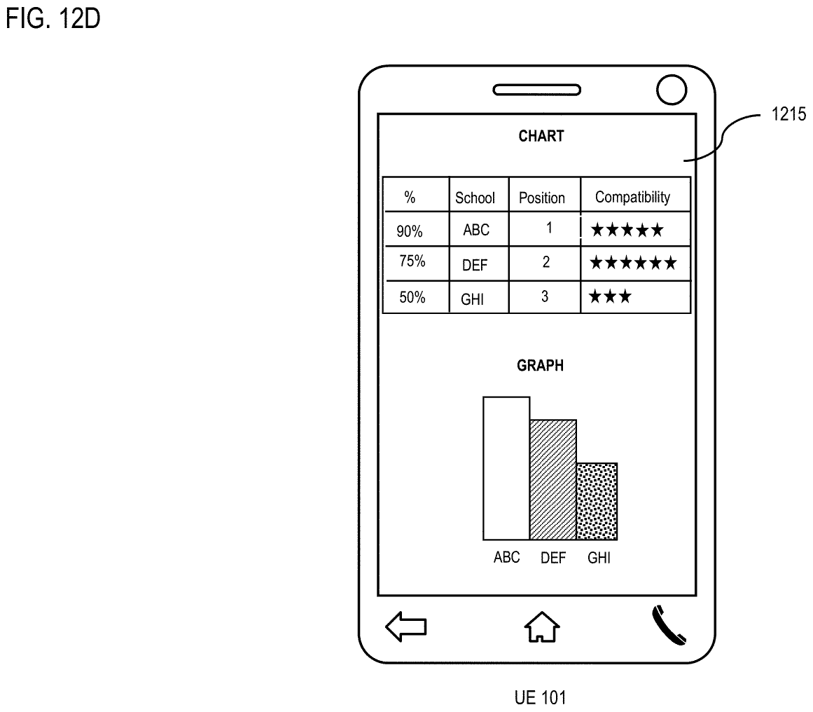

In step 309, evaluation platform 109 initiates presentation of the one or more matching institutions to the first device, e.g., UE 101a. In one example embodiment, evaluation platform 109 may display a chart representing the plurality of institutions based on popularity scores, location proximity, the one or more athlete's preference information, selectivity level, or a combination thereof in a user interface of UE 101a, as represented in FIG. 12A. In one example embodiment, the plurality of institutions is ranked based on probability of acceptance of the candidate user by the institution.

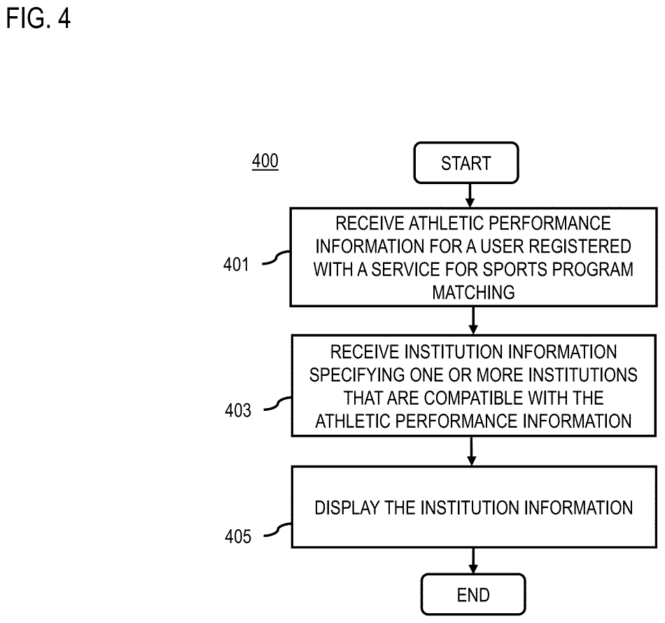

FIG. 4 is a flowchart of a process for displaying a plurality of institutions compatible with the registered user, according to one embodiment. In one embodiment, evaluation platform 109 performs the process 400 and is implemented in, for instance, a chip set including a processor and a memory as shown in FIG. 18.

In step 401, evaluation platform 109 receives athletic performance information for a user registered with a service platform for sports program matching. In one embodiment, the registered users input the athletic performance information via a graphical user interface (GUI) of a device, e.g., UE 101a, as illustrated in FIGS. 5-7 and 9A-9E. The athletic performance information comprises an athletic performance test result of the overall athletic performance of the candidate user, e.g., total athletic performance data pertaining to vertical jump of an athlete, total time to complete an agility shuttle, a kneeling power-ball toss, sprint time of the athlete over a 40-yard distance, or a peak power-vertical jump. Then, the device associated with a registered user, e.g., UE 101a, initiates the transmission of the athletic performance information to the service platform, e.g., evaluation platform 109.

In step 403, evaluation platform 109 receives institution information specifying one or more institutions, e.g., college, university, sports organizations, etc., that are compatible with the athletic performance information. In one example embodiment, institution information comprises selection criteria, e.g., average athletic performance scores, average GPA, average scholastic assessment test (SAT) scores, average interview performance scores, etc., required for a sports program.

In step 405, evaluation platform 109 displays, via the graphical user interface, information pertaining to the plurality of institutions. In one embodiment, the graphical user interface comprises of a first section for presenting icons, e.g. web page icons, chart icons, logos, representing the plurality of institutions. Furthermore, the graphical user interface comprises of a second section for presenting menus, buttons, and data entry fields representing general information pertaining to the one or more institutions, as represented in FIGS. 12A and 12B. In one embodiment, the icons comprise web page icons. The evaluation platform 109 detects activation of one of the web page icons based on touch-based user input. Thereafter, evaluation platform 109 displays, via the graphical user interface, a web page that corresponds to the activated web page icon in a user device, e.g., UE 101a, as depicted in FIG. 12C.

In another embodiment, the icons comprise a chart icon. The evaluation platform 109 detects activation of the chart icon based on touch-based user input. Thereafter, evaluation platform 109 displays, via the graphical user interface, a chart that represents a ranking of the one or more institutions in a user device, e.g., UE 101a. In one example embodiment, the ranking is based on selection criteria associated with sports programs of the one or more institutions, as represented in FIG. 12D.

In a further embodiment, evaluation platform 109 detects a selection of the icons, the buttons, the menus, and the data entry fields. Then, the evaluation platform 109 modifies the appearance of the icons, the buttons, the menus, and the data entry fields. In one example embodiment, modifying the appearance of the icons comprises changing color, shape, size, or a combination thereof of the icons, the buttons, the menus, and the data entry fields, as illustrated in FIGS. 12A-12D.

In one embodiment, positioning of the icons, the buttons, and the data entry fields in the graphical user interface is based on metadata, user inputs, or a combination thereof. In another embodiment, the general information comprises names of one or more institutions, locations of one or more institutions, sports programs in one or more institutions, academic programs in one or more institutions, and scholarship information for the academic programs.

FIG. 5 is a user interface diagram that represents a log-in screen to access the service, according to one example embodiment. In one example embodiment, an existing user may provide a preset username and password via a graphical user interface (GUI) 501 to log-in and access the service. In another example embodiment, an existing user may enter device identification information, e.g., international mobile equipment identity (IMEI), an electronic serial number, a mobile equipment identity (MEID), or other identifiers unique to the device, via GUI 501 to log-in and access the service. In a further example embodiment, a user may use log-in credentials of other social networking services via GUI 501 to log-in and access the service. In an additional embodiment, other authentication mechanisms, e.g., fingerprint log-in or facial recognition log-in, may be implemented based on device capability for log-in. The UE 101 may display an error notification, e.g., invalid log-in, to notify the user that the log-in credentials were incorrect.

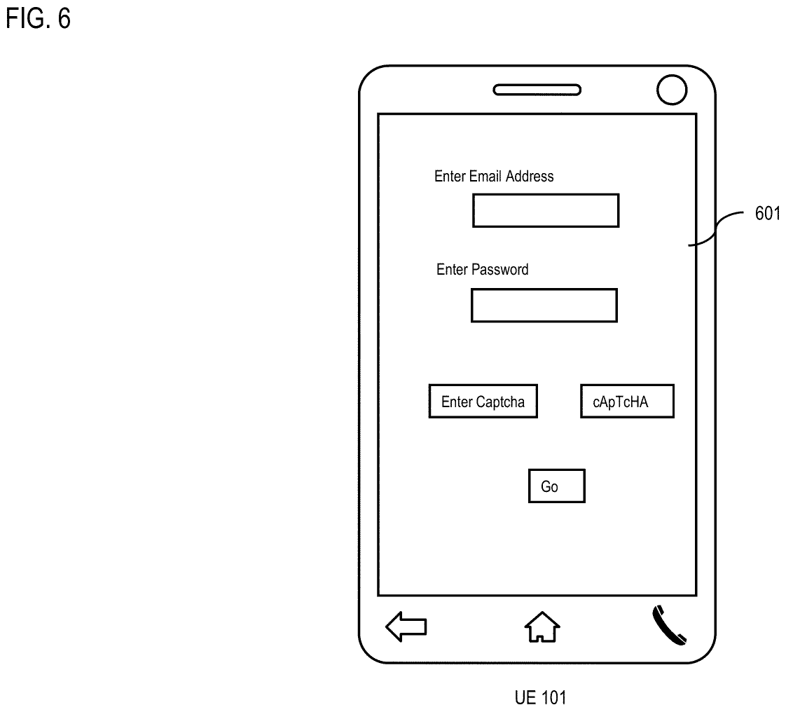

FIG. 6 is a user interface diagram that represents a sign-up screen for coaches to access a service, according to one example embodiment. In one example embodiment, a new user, e.g., a coach, may sign-up by providing a valid email address and a password via GUI 601. The password entered by the user must be of a specified length and must contain a number. The user may be asked to enter a ‘captcha’ to prevent automated software from creating fake accounts.

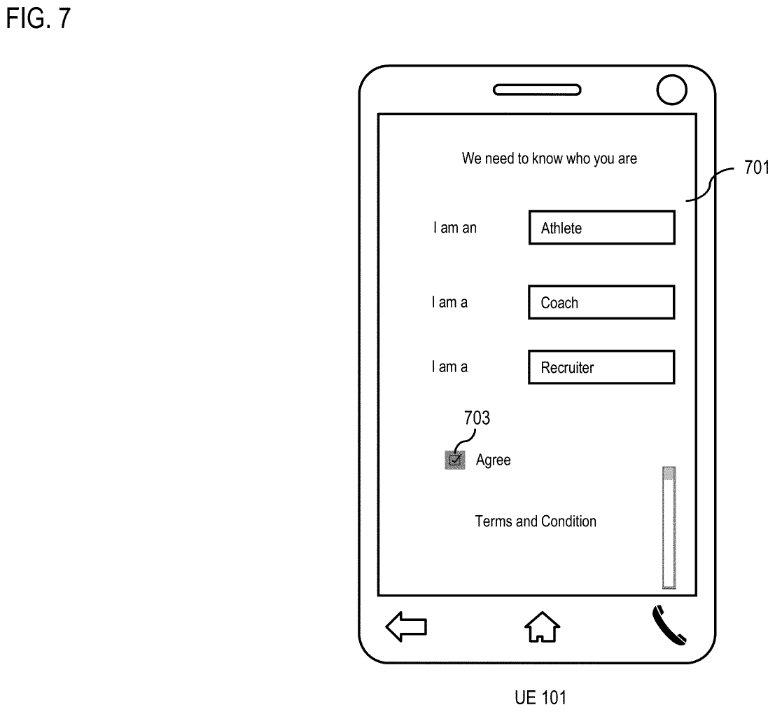

FIG. 7 is a user interface diagram that represents a notification screen alerting a user to select a user type and accept the terms of conditions to access the service, according to one example embodiment. In one example embodiment, a user must choose a user type, e.g., either a coach or an athlete, via GUI 701. Then, the user must accept the terms and condition by clicking GUI 703, i.e., the agree box. Thereafter, GUI 701 automatically navigates to the next screen associated with the user type, e.g., either the athlete input screen or the coach input screen.

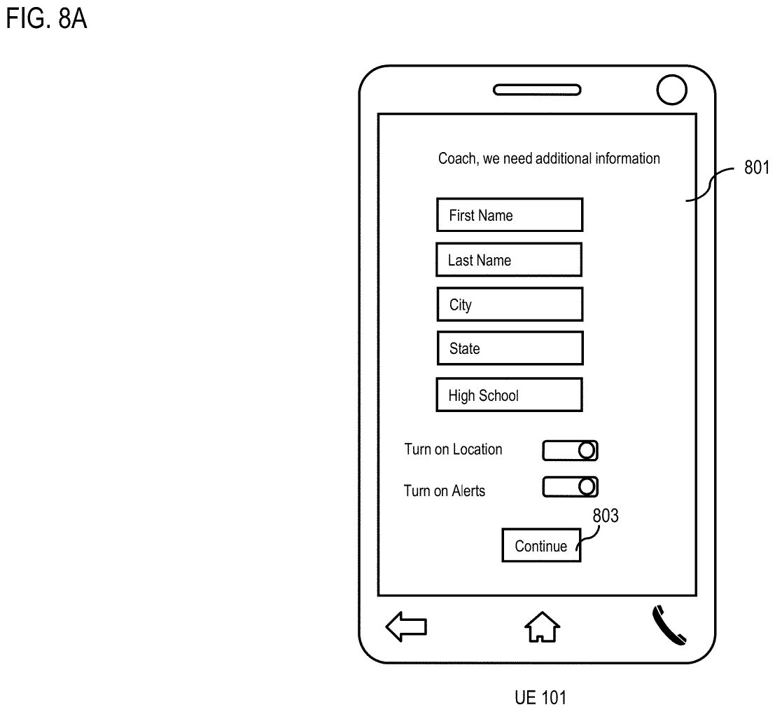

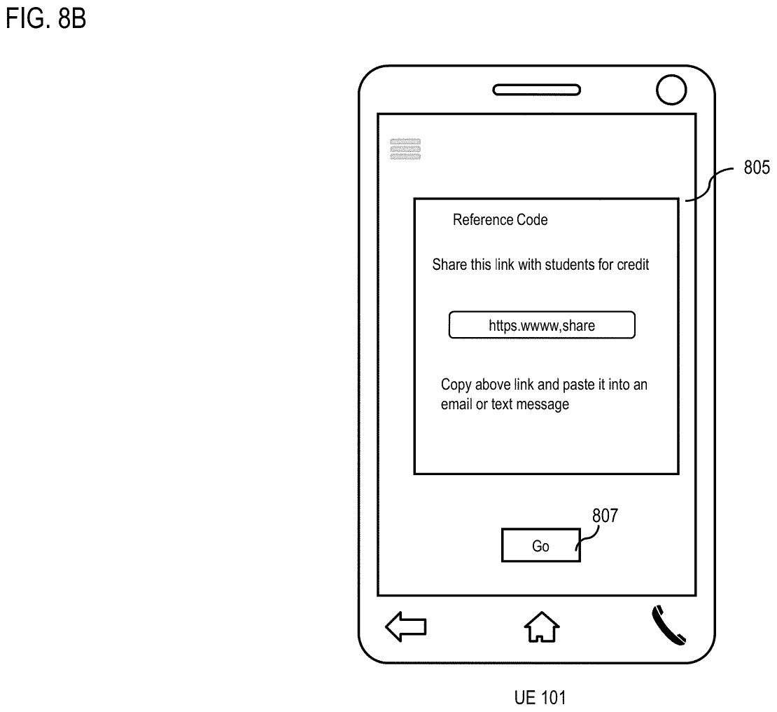

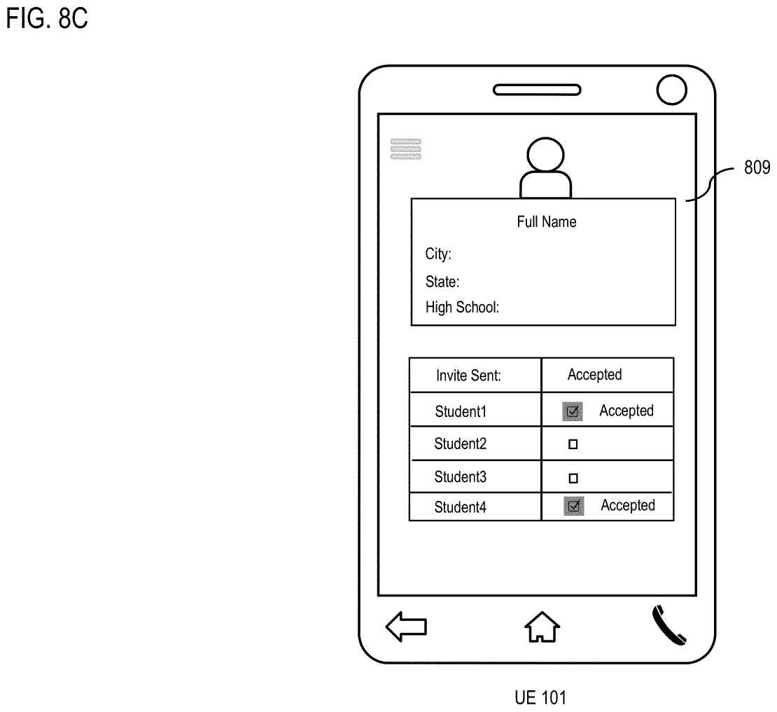

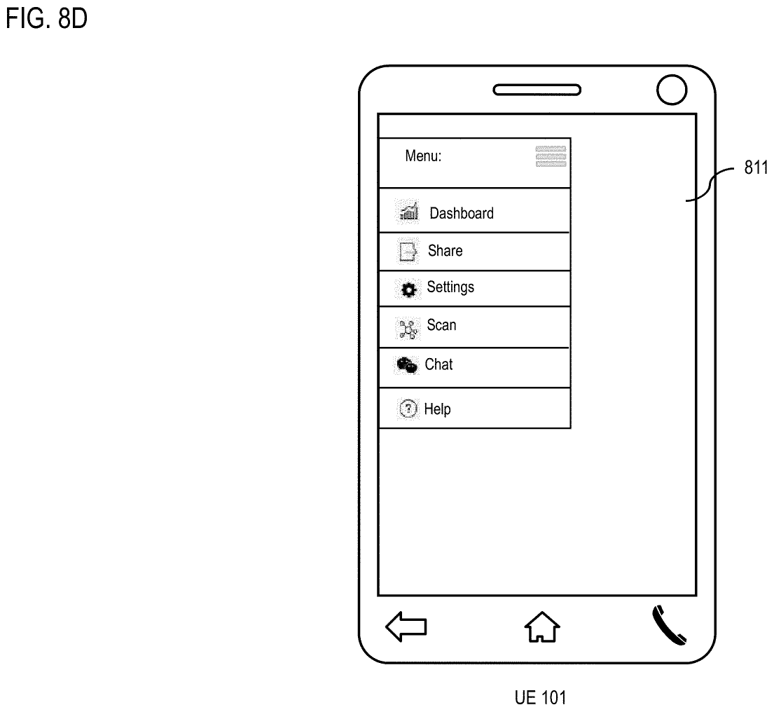

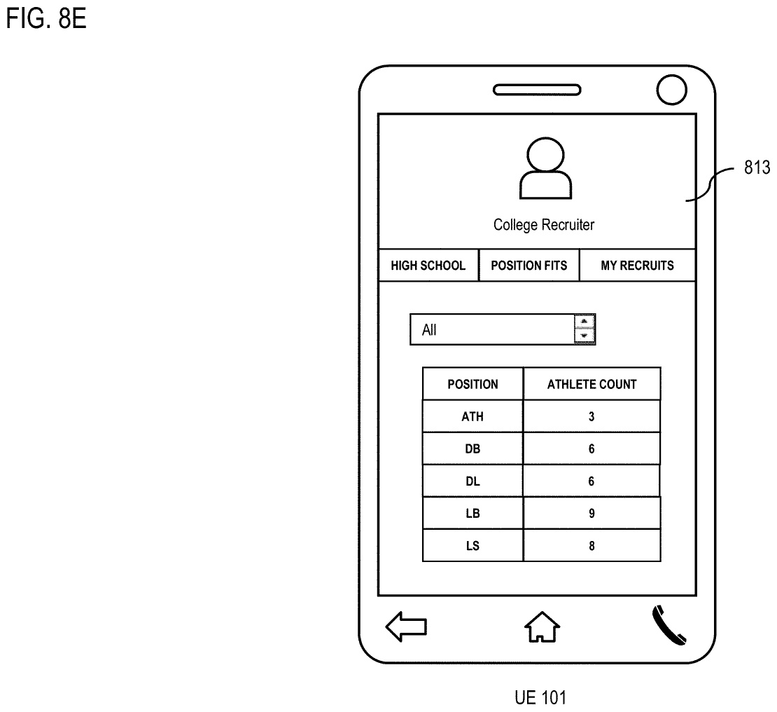

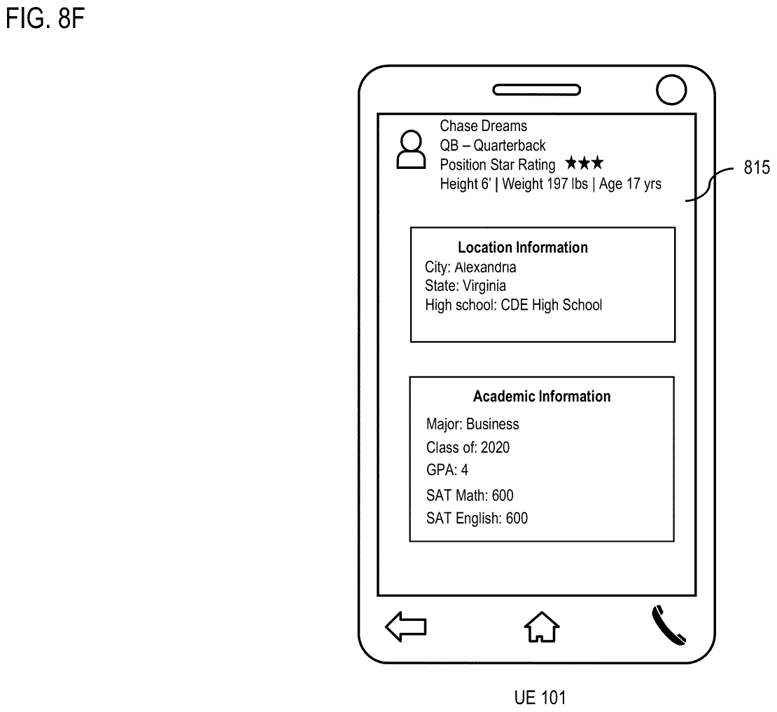

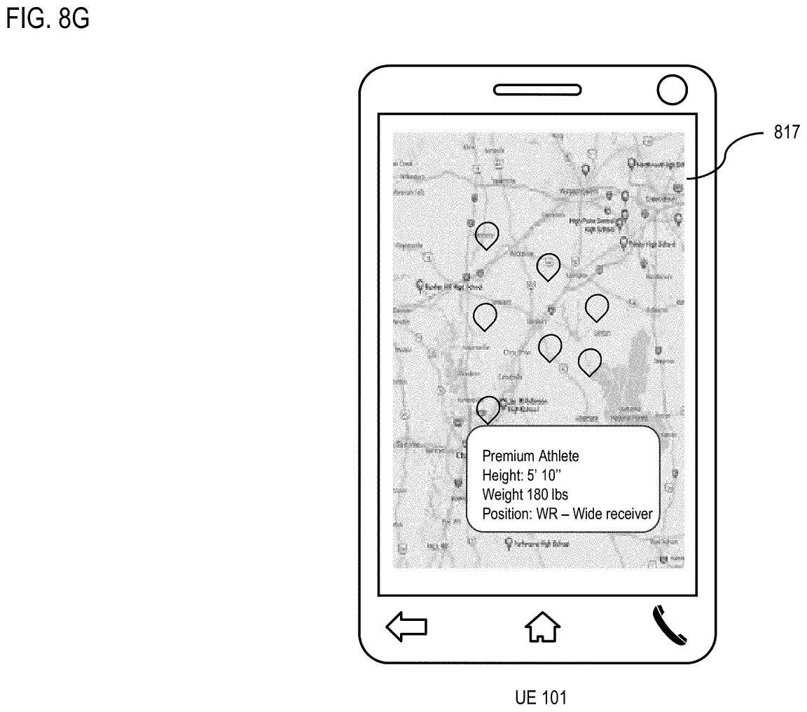

FIG. 8A is a user interface diagram that represents a sign-up screen for coaches to access the service, according to one example embodiment. In one example embodiment, a coach is required to enter his/her first name, last name, city, state, and high school via GUI 801. In one embodiment, the coach may choose to turn on the location via GUI 801, thereby allowing the evaluation platform 109 to track the coach via location-based services, e.g., global positioning satellite (GPS), short-range communications, or sensor information. In another embodiment, the coach may choose to turn on the alerts via GUI 801, whereupon the evaluation platform 109 may notify the coach as soon as certain athletes using the UE 101 application are within a distance threshold, e.g., close proximity. Subsequently, the coach may press GUI 803, e.g., continue button, to save the data to a shared database.

FIG. 8B is a user interface diagram that represents a reference code screen, according to one example embodiment. In one embodiment, the evaluation platform 109 may create a reference number using the username entered by the coach in FIG. 8A. In one example embodiment, the evaluation platform 109 may create a link, the coach may click the link via GUI 805 whereupon the link is automatically copied to memory and may be pasted into a text or an email. Then, the coach may click GUI 807, e.g., next button, to go to the profile/dashboard page.

FIG. 8C is a user interface diagram that represents a profile/dashboard screen for the coach, according to one example embodiment. As represented in FIG. 8C, GUI 809 shows a number of invites sent to the plurality of current users and the status of the invites.

FIG. 8D is a user interface diagram that represents a menu screen for the coach, according to one example embodiment. As illustrated in FIG. 8D, the coach can access the dashboard, share the data, access the settings, scan the area, chat with other users, or access help simply by pressing at least one button in GUI 811. In one example embodiment, the menu screen displayed for a coach is different from the menu screen for an athlete.

FIGS. 8E-8G are user interface diagrams that represent athlete profile data for recruiters, according to one example embodiment. As depicted in FIG. 8E, a recruiter registered with the service may access athlete profile data 813 via his/her mobile device, i.e., UE 101. The recruiter may verify the accessed athlete profile data as well as college fit data of an athlete through the use of the sports program matching service. Furthermore, the recruiter may read reviews and ratings pertaining to one or more athletes. In one example embodiment, the registration process for a recruiter is similar to that of an athlete or a coach.

In one example embodiment, a registered recruiter may be presented with a list of athletes in his/her mobile device, i.e., UE 101. The recruiter may choose an athlete from the list display via a touch-based input. Thereafter, the evaluation platform 109 causes a presentation of user interface 815 (FIG. 8F). The user interface 815 displays athlete profile data comprising username, playing position, rating, height, weight, age, location information, and academic information.

FIG. 8G is a user interface diagram that represents location information of one or more athletes, according to one example embodiment. In one embodiment, registered recruiters are presented with a user interface display 817 in his/her UE 101. Display 817 provides a real-time location or registered location of one or more athletes. Furthermore, registered recruiters can track and manage athletes.

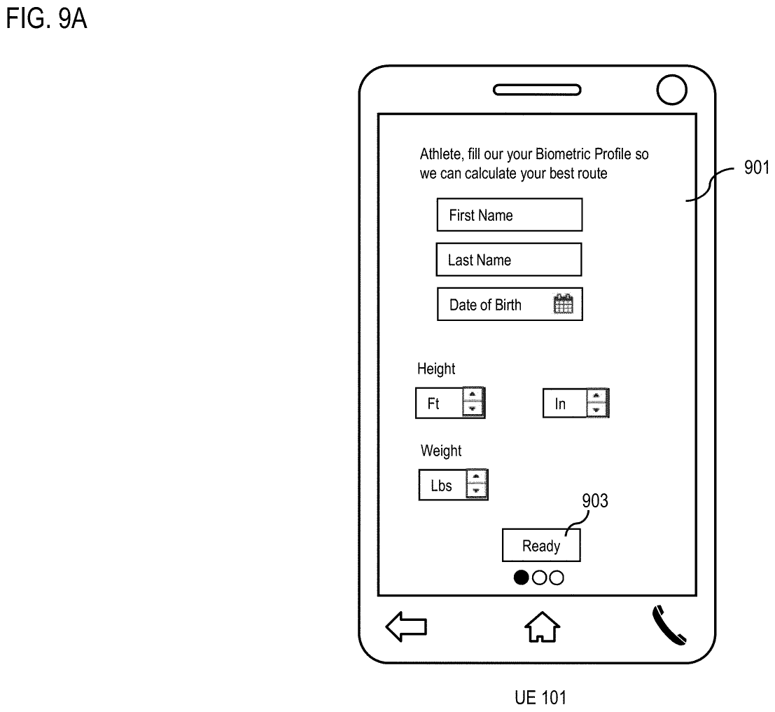

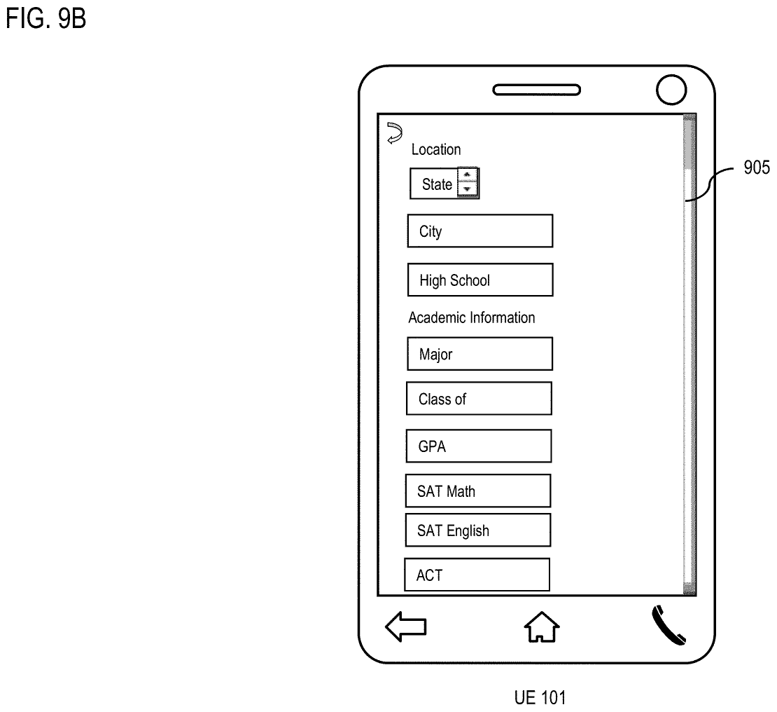

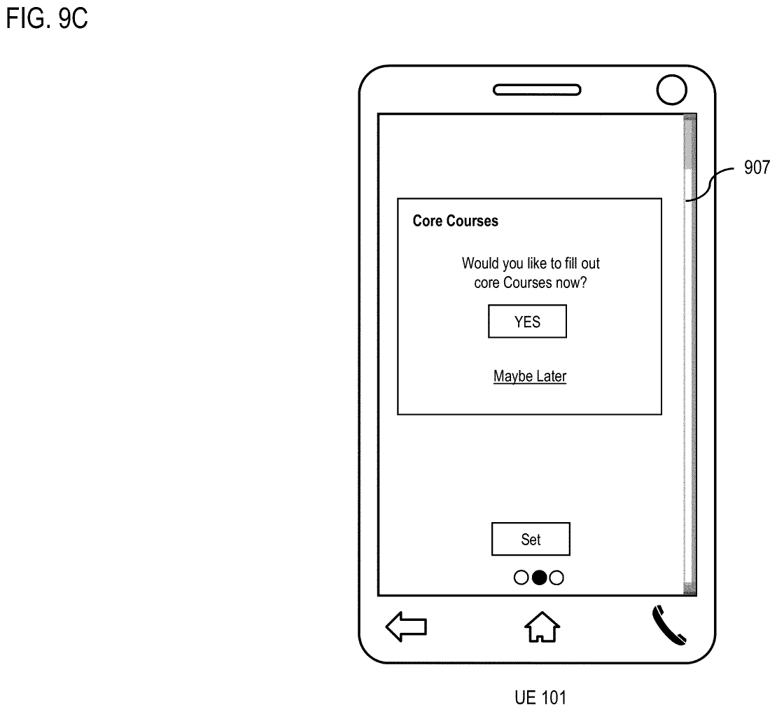

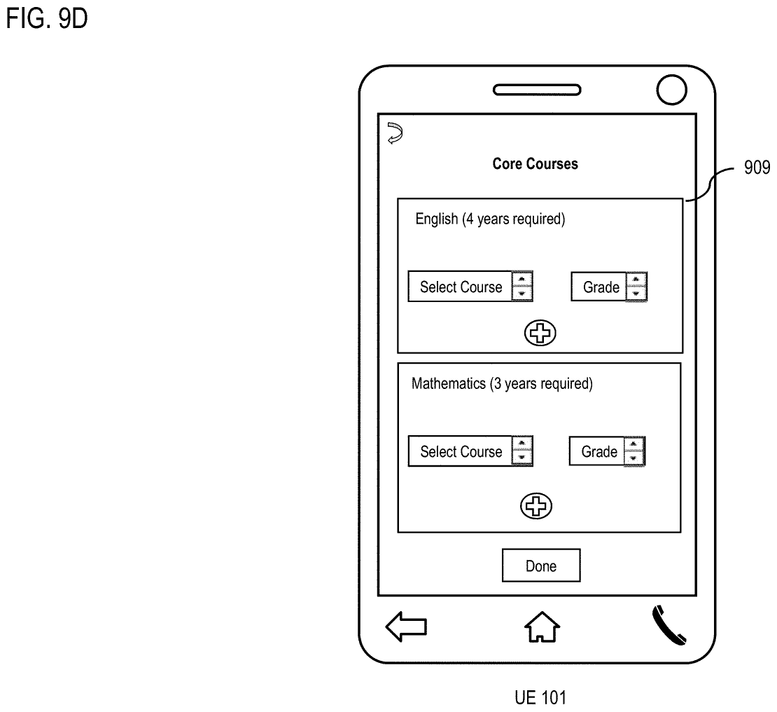

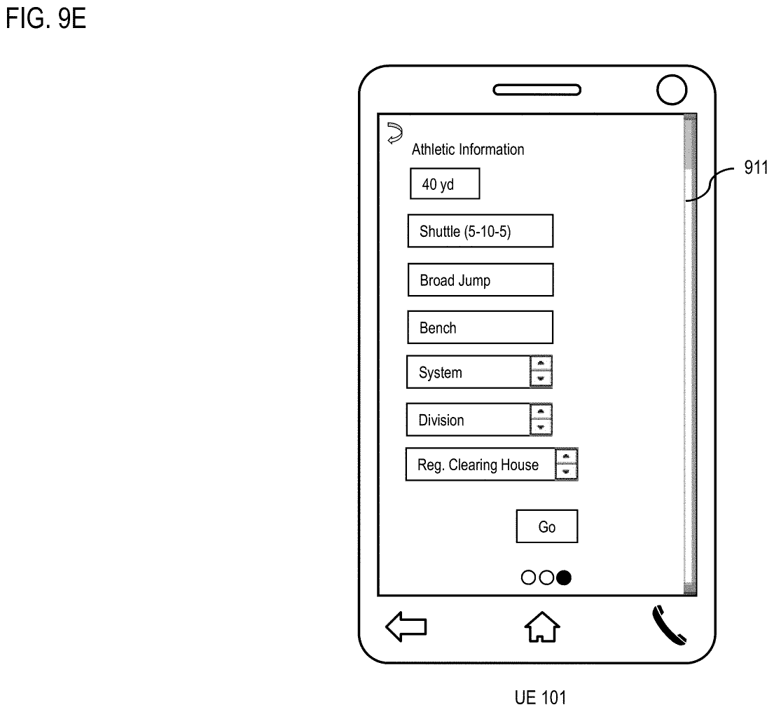

FIGS. 9A-9E are user interface diagrams that represent sign-up screens for athletes to access the service, according to one example embodiment. In FIG. 9A, a new user, e.g., an athlete, may sign-up by entering his/her full name, date of birth (D.O.B), height, and weight via GUI 901. The new user must provide information for all the fields, i.e., first name, last name, D.O.B, height, and weight, otherwise the empty fields are highlighted in red and an error message is presented above the empty fields. Thereafter, the user may press GUI 903, i.e., ready button, to go to the next page of the sign-up screen. Adverting to FIG. 9B, the new user must enter his/her location information, e.g., state and city, and academic information, e.g., high-school, major, class of, grade point average (GPA), SAT math, SAT English, and ACT via GUI 905. The new user must provide information for all the fields, otherwise the empty fields are highlighted in red and an error message is presented above the empty fields. Referring to FIG. 9C, the new user is given an option to select core courses via GUI 907. The user may either choose to select core courses immediately or may decide to choose them at a later period. Adverting to FIG. 9D, if the user decides to select core courses then he/she may enter academic data for the core courses via GUI 909. The user may enter a course and the grade obtained in that course. In one embodiment, the evaluation platform 109 may calculate quality points based, at least in part, on the credit and the grade. As illustrated in FIG. 9E, the new user must enter his/her athletic information via GUI 911. The new user must provide information for all the fields, otherwise the empty fields are highlighted in red and an error message is presented above the empty fields.

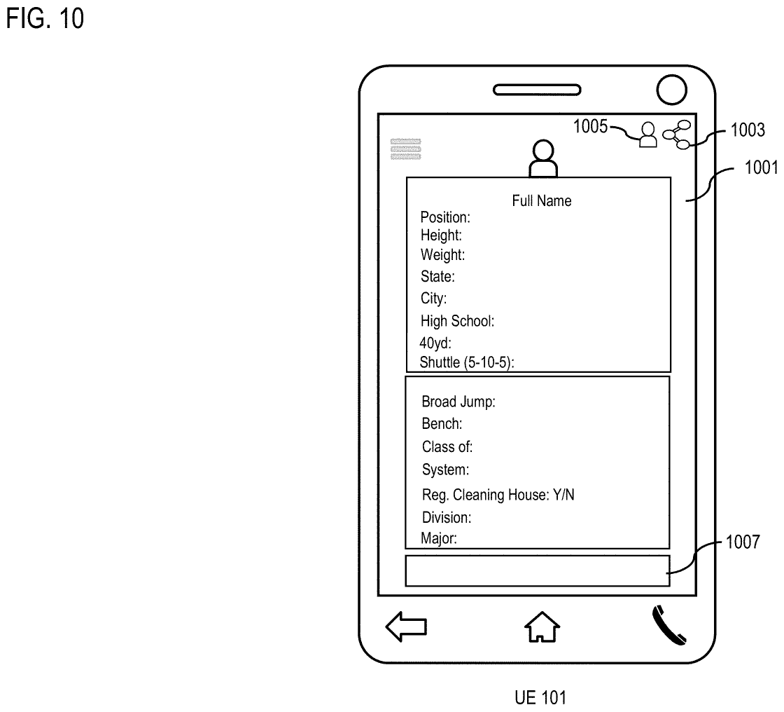

FIG. 10 is a user interface diagram that represents a dashboard for an athlete, according to one example embodiment. As depicted, dashboard 1001 comprises personal information, location information, e.g., users may set a search radius for searching for an institution, and sports-related information of an athlete. In one example embodiment, dashboard 1001 may also comprise academic information of an athlete. In one embodiment, a user may share the information presented in dashboard 1001 by clicking the share button 1003. In another embodiment, a user may edit the information presented in dashboard 1001 by clicking edit button 805. In one example embodiment, when a user clicks edit button 1005, all fields become editable and a social media bar 1007 appears at the bottom of the screen of UE 101. The user may add social media links and news feed to his/her personal accounts.

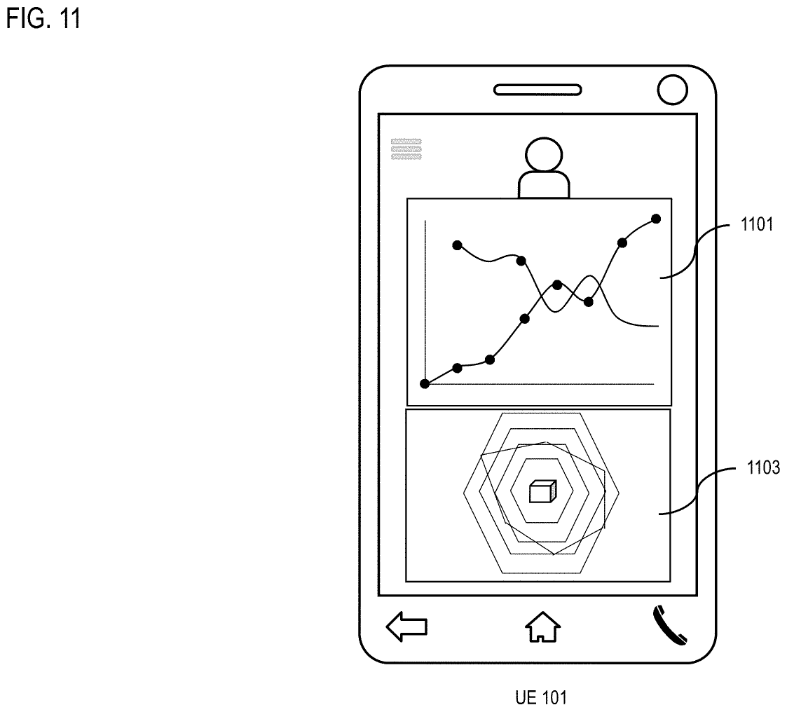

FIG. 11 is a user interface diagram that represents a chart for an athlete, according to one example embodiment. In one example embodiment, chart 1101 and 1103 may be a graph of varying shapes and sizes that represent numerous attributes of an athlete. In one embodiment, the chart for an athlete is based, at least in part, on personal information, academic information, and sports-related information of an athlete.

FIG. 12A is a user interface diagram that represents a dashboard for an athlete, according to one example embodiment. In one embodiment, dashboard 1201 comprises statistics information for an athlete, e.g., probability information for the athlete playing at schools/universities in a position of his/her choice. In another embodiment, dashboard 1201 comprises a rating on the recruitment process of schools/universities by one or more users, e.g., athletes, coaches, etc. In a further example embodiment, dashboard 1201 comprises a table with an athlete's information and an average of the athletes in a particular school.

FIG. 12B is a user interface diagram that represents a graphical user interface displaying institution information, according to one example embodiment. In one embodiment, the graphical user interface 1203 comprises a first section 1205 and a second section 1207. In one example embodiment, the first section 1205 comprises icons, e.g., webpage icons, logos, chart icons, etc., representing the one or more institutions. The second section 1207 comprises menus, buttons, and data entry fields representing general information pertaining to the one or more institutions. The general information comprises names of one or more institutions, locations of one or more institutions, sports programs in one or more institutions, academic programs in one or more institutions, and scholarship information for the academic programs.

FIG. 12C is a user interface diagram that represents a webpage of an institution in a graphical user interface of a user device, according to one example embodiment. In one embodiment, the evaluation platform 109 detects activation of a web page icon 1209 based on touch-based user input. Thereafter, evaluation platform 109 displays a web page that corresponds to the activated web page icon 1207 in a graphical user interface 1213 of a device, e.g., UE 101a.

FIG. 12D is a user interface diagram that represents a graphical user interface displaying a chart for one or more institutions, according to one example embodiment. In one embodiment, the evaluation platform 109 detects activation of a chart icon 1211 based on touch-based user input. Thereafter, evaluation platform 109 displays a chart and a graph that represent a ranking of one or more institutions in a graphical user interface 1215 of a device, e.g., UE 101a. In one embodiment, the ranking is based on selection criteria associated with sports programs of one or more institutions.

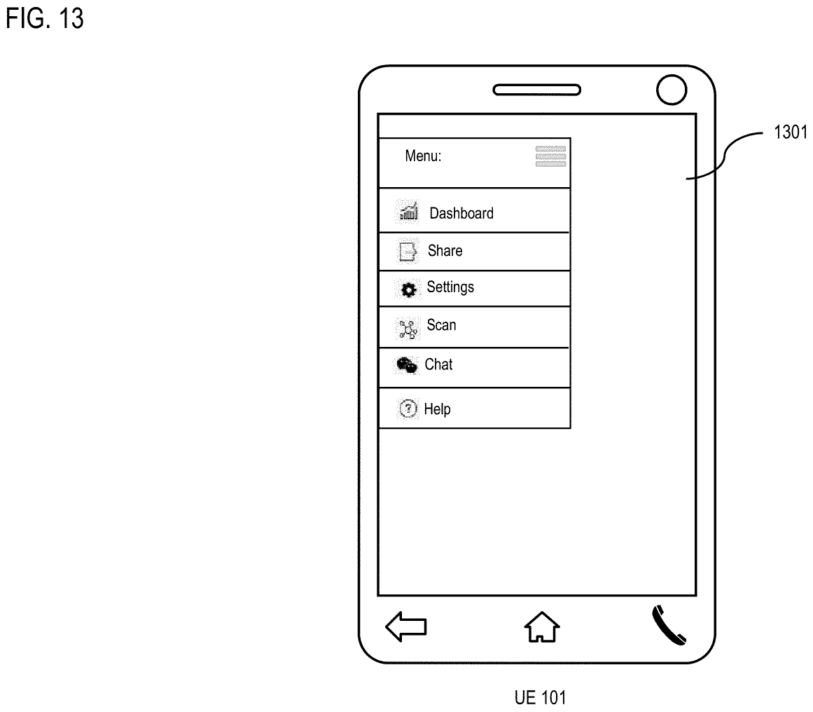

FIG. 13 is a user interface diagram that represents a menu screen for an athlete, according to one example embodiment. As illustrated in FIG. 13, the athlete can access the dashboard, share the data, access the settings, scan the area, chat with other users, or access help simply by pressing at least one button in GUI 1301. In one example embodiment, the menu screen displayed for an athlete is different from the menu screen for a coach.

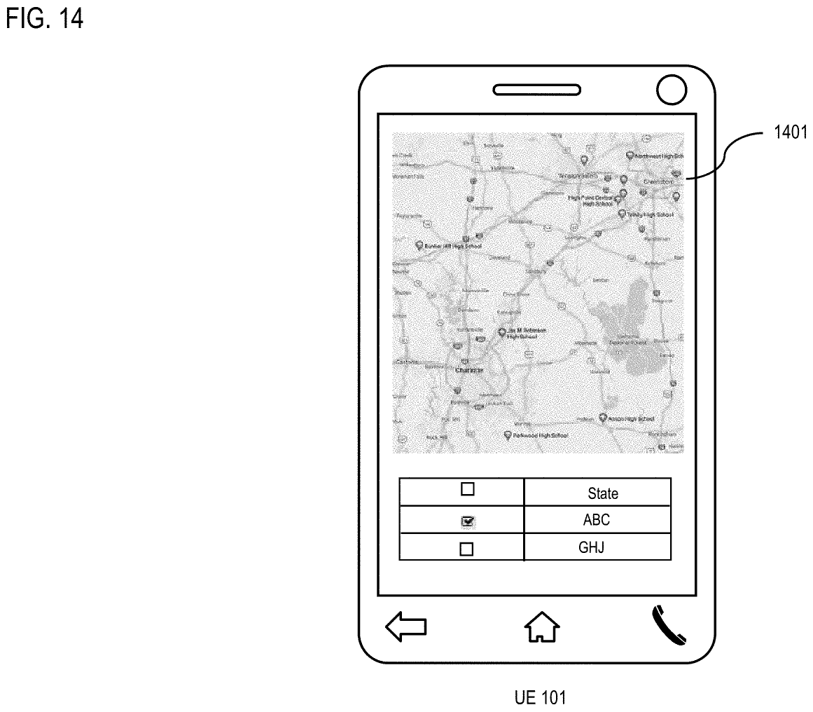

FIG. 14 is a user interface diagram that represents location information of registered users, according to one example embodiment. In one embodiment, user interface 1401 displays location information for a plurality of registered users, e.g., student athletes, coaches, and recruiters that allows GPS sharing. In another embodiment, user interface 1401 displays location information of one or more institutions, e.g., universities, training facilities, etc.

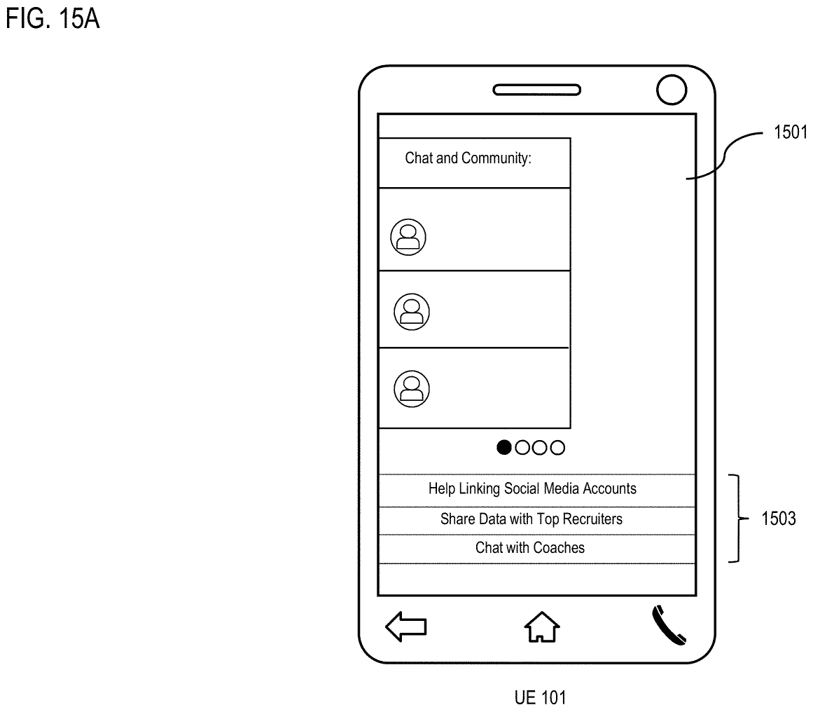

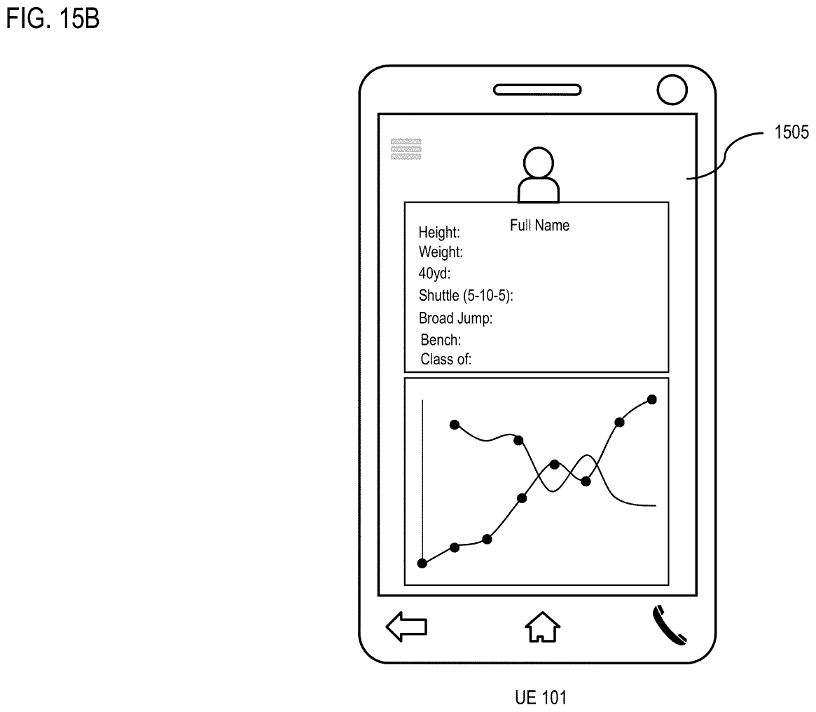

FIG. 15A is a user interface diagram that represents a chat forum, according to one example embodiment. In one embodiment, the plurality of users may communicate with each other via chat forum displayed in user interface 1501, e.g., athletes can chat with other athletes, athletes can chat with coaches, etc. In another example embodiment, the plurality of users may use the chat forum displayed in user interface 1503 to communicate with coaches, recruiters, or share their information by linking it to social media accounts.

FIG. 15B is a user interface diagram that represents an athlete's profile for sharing, according to one example embodiment. In one example embodiment, an athlete may choose to share his/her profile with other users, e.g., an athlete or a coach, or a third party, e.g., a recruiter, or on social media, by selecting GUI 1503. Subsequently, evaluation platform 109 creates a user profile 1505 for sharing. The user profile 1505 comprises academic data, athletic data, and probability graphs of an athlete. In another example embodiment, evaluation platform 109 may create a pdf document comprising academic data, athletic data, and probability graphs for an athlete, and the athlete may share the pdf document with other users or a third party via email.

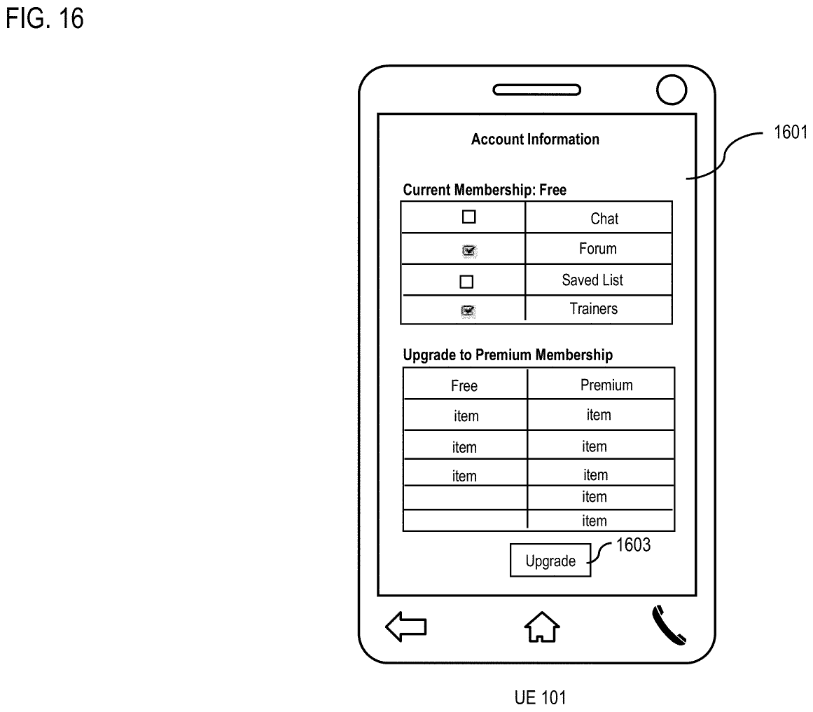

FIG. 16 is a user interface diagram that represents account information of a registered user, according to one example embodiment. In one embodiment, the account information 1601 comprises an item comparison list showing resources available for users with a free membership and users with a premium membership. In one example embodiment, users with a free membership may upgrade to a premium membership by clicking GUI 1603, e.g., GUI 1603 allows a transaction to take place to upgrade free membership to paid membership. The users with paid membership have access to services normally not available to users with free membership.

It is contemplated that the various described GUIs can be implemented according to various “look and feel” such as those depicted in the Appendix.

The processes described herein for matching a candidate user to an institution based on athletic performance information, athletic observation information, and selection criteria may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

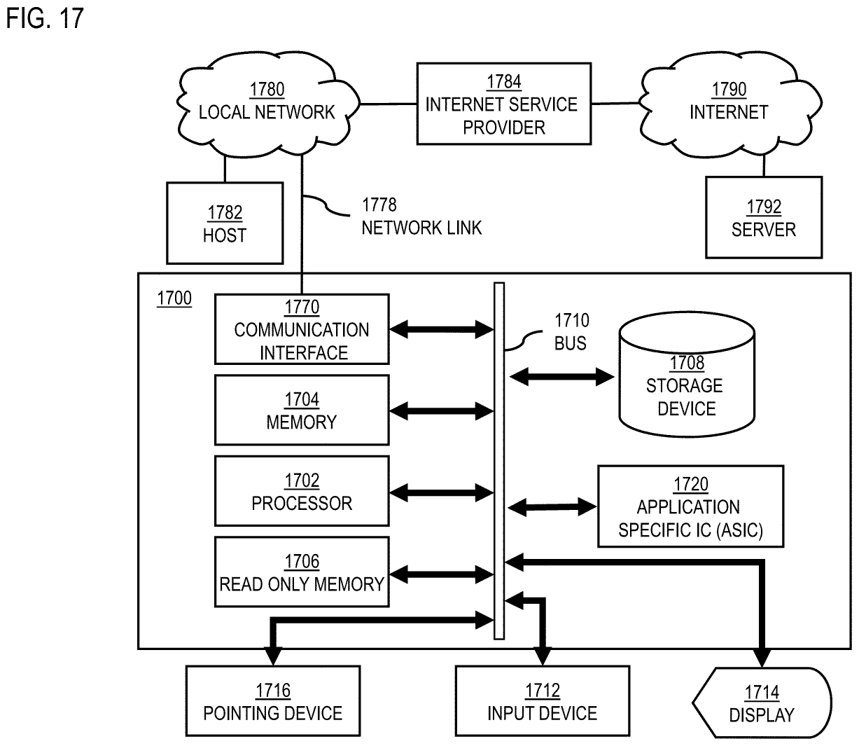

FIG. 17 illustrates a computer system 1700 upon which an embodiment of the invention may be implemented. Computer system 1700 is programmed (e.g., via computer program code or instructions) to match a candidate user to an institution based on athletic performance information, athletic observation information, and selection criteria as described herein and includes a communication mechanism such as a bus 1710 for passing information between other internal and external components of the computer system 1700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 1710 includes one or more parallel conductors of information so that information is transferred quickly among devices coupled to the bus 1710. One or more processors 1702 for processing information are coupled with the bus 1710.

A processor 1702 performs a set of operations on information as specified by computer program code related to match a candidate user to an institution based on athletic performance information, athletic observation information, and selection criteria. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1710 and placing information on the bus 1710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 1700 also includes a memory 1704 coupled to bus 1710. The memory 1704, such as a random access memory (RAM) or other dynamic storage device, stores information including processor instructions for matching a candidate user to an institution based on athletic performance information, athletic observation information, and selection criteria. Dynamic memory allows information stored therein to be changed by the computer system 1700. RAM allows a unit of information stored at a location called a memory address to be stored and retrieved independently of information at neighboring addresses. The memory 1704 is also used by the processor 1702 to store temporary values during execution of processor instructions. The computer system 1700 also includes a read only memory (ROM) 1706 or other static storage device coupled to the bus 1710 for storing static information, including instructions, that is not changed by the computer system 1700. Some memory is composed of volatile storage that loses the information stored thereon when power is lost. Also coupled to bus 1710 is a non-volatile (persistent) storage device 1708, such as a magnetic disk, optical disk or flash card, for storing information, including instructions, that persists even when the computer system 1700 is turned off or otherwise loses power.

Information, including instructions for matching a candidate user to an institution based on athletic performance information, athletic observation information, and selection criteria, is provided to the bus 1710 for use by the processor from an external input device 1712, such as a keyboard containing alphanumeric keys operated by a human user, or a sensor. A sensor detects conditions in its vicinity and transforms those detections into physical expression compatible with the measurable phenomenon used to represent information in computer system 1700. Other external devices coupled to bus 1710, used primarily for interacting with humans, include a display device 1714, such as a cathode ray tube (CRT) or a liquid crystal display (LCD), or plasma screen or printer for presenting text or images, and a pointing device 1716, such as a mouse or a trackball or cursor direction keys, or motion sensor, for controlling a position of a small cursor image presented on the display 1714 and issuing commands associated with graphical elements presented on the display 1714. In some embodiments, for example, in embodiments in which the computer system 1700 performs all functions automatically without human input, one or more of external input device 1712, display device 1714 and pointing device 1716 is omitted.

In the illustrated embodiment, special purpose hardware, such as an application specific integrated circuit (ASIC) 1720, is coupled to bus 1710. The special purpose hardware is configured to perform operations not performed by processor 1702 quickly enough for special purposes. Examples of application specific ICs include graphics accelerator cards for generating images for display 1714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1700 also includes one or more instances of a communications interface 1770 coupled to bus 1710. Communication interface 1770 provides a one-way or two-way communication coupling to a variety of external devices that operate with their own processors, such as printers, scanners and external disks. In general, the coupling is with a network link 1778 that is connected to a local network 1780 to which a variety of external devices with their own processors are connected. For example, communication interface 1770 may be a parallel port or a serial port or a universal serial bus (USB) port on a personal computer. In some embodiments, communications interface 1770 is an integrated services digital network (ISDN) card or a digital subscriber line (DSL) card or a telephone modem that provides an information communication connection to a corresponding type of telephone line. In some embodiments, a communication interface 1770 is a cable modem that converts signals on bus 1710 into signals for a communication connection over a coaxial cable or into optical signals for a communication connection over a fiber optic cable. As another example, communications interface 1770 may be a local area network (LAN) card to provide a data communication connection to a compatible LAN, such as Ethernet. Wireless links may also be implemented. For wireless links, the communications interface 1770 sends or receives or both sends and receives electrical, acoustic or electromagnetic signals, including infrared and optical signals, that carry information streams, such as digital data. For example, in wireless handheld devices, such as mobile telephones like cell phones, the communications interface 1770 includes a radio band electromagnetic transmitter and receiver called a radio transceiver. In certain embodiments, the communications interface 1770 enables connection to the communication network 107 for matching a candidate user to an institution based on athletic performance information, athletic observation information, and selection criteria to the UE 101.

The term computer-readable medium is used herein to refer to any medium that participates in providing information to processor 1702, including instructions for execution. Such a medium may take many forms, including, but not limited to, non-volatile media, volatile media and transmission media. Non-volatile media include, for example, optical or magnetic disks, such as storage device 1708. Volatile media include, for example, dynamic memory 1704.

Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 1778 typically provides information communication using transmission media through one or more networks to other devices that use or process the information. For example, network link 1778 may provide a connection through local network 1780 to a host computer 1782 or to equipment 1784 operated by an Internet Service Provider (ISP). ISP equipment 1784 in turn provides data communication services through the public, world-wide packet-switching communication network of networks now commonly referred to as the Internet 1790.

A computer called a server host 1792 connected to the Internet hosts a process that provides a service in response to information received over the Internet. For example, server host 1792 hosts a process that provides information representing video data for presentation at display 1714. It is contemplated that the components of system can be deployed in various configurations within other computer systems, e.g., host 1782 and server 1792.

FIG. 18 illustrates a chip set 1800 upon which an embodiment of the invention may be implemented. Chip set 1800 is programmed to match a candidate user to an institution based on athletic performance information, athletic observation information, and selection criteria as described herein and includes, for instance, the processor and memory components described with respect to FIG. 17 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 1800 includes a communication mechanism such as a bus 1801 for passing information among the components of the chip set 1800. A processor 1803 has connectivity to the bus 1801 to execute instructions and process information stored in, for example, a memory 1805. The processor 1803 may include one or more processing cores with each core configured to perform independently. A multi-core processor enables multiprocessing within a single physical package. Examples of a multi-core processor include two, four, eight, or greater numbers of processing cores. Alternatively or in addition, the processor 1803 may include one or more microprocessors configured in tandem via the bus 1801 to enable independent execution of instructions, pipelining, and multithreading. The processor 1803 may also be accompanied with one or more specialized components to perform certain processing functions and tasks such as one or more digital signal processors (DSP) 1807, or one or more application-specific integrated circuits (ASIC) 1809. A DSP 1807 typically is configured to process real-world signals (e.g., sound) in real time independently of the processor 1803. Similarly, an ASIC 1809 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1803 and accompanying components have connectivity to the memory 1805 via the bus 1801. The memory 1805 includes both dynamic memory (e.g., RAM, magnetic disk, writable optical disk, etc.) and static memory (e.g., ROM, CD-ROM, etc.) for storing executable instructions that when executed perform the inventive steps described herein to match a candidate user to an institution based on athletic performance information, athletic observation information, and selection criteria. The memory 1805 also stores the data associated with or generated by the execution of the inventive steps.

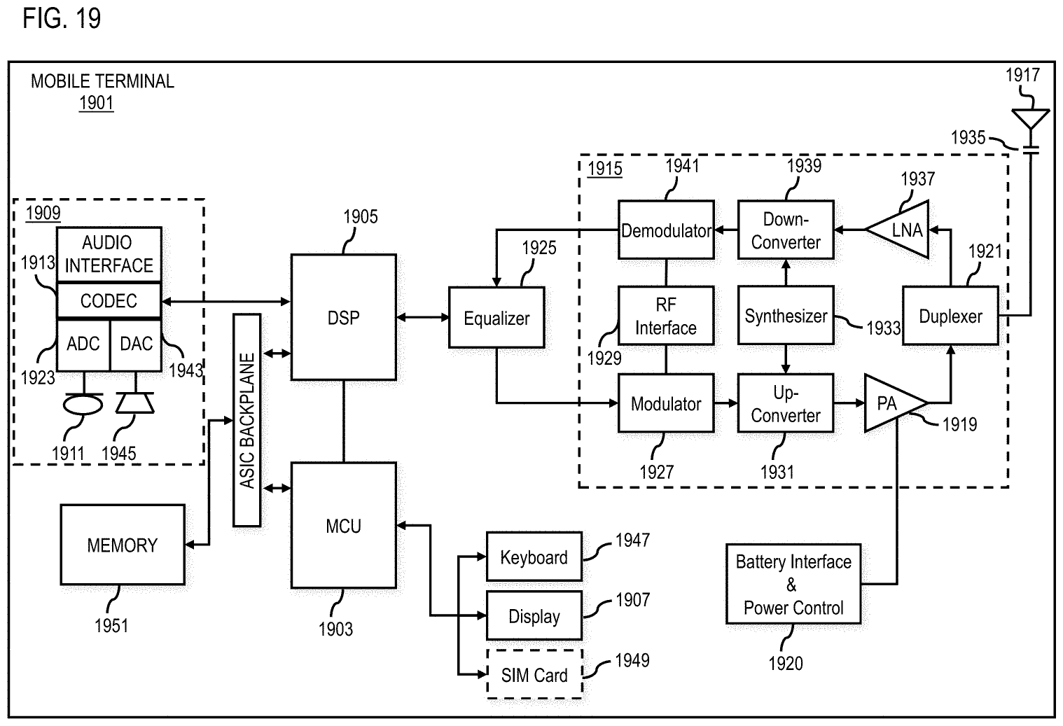

FIG. 19 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1903, a Digital Signal Processor (DSP) 1905, and a receiver/transmitter unit including a microphone gain control unit and a speaker gain control unit. A main display unit 1907 provides a display to the user in support of various applications and mobile station functions that offer automatic contact matching. An audio function circuitry 1909 includes a microphone 1911 and microphone amplifier that amplifies the speech signal output from the microphone 1911. The amplified speech signal output from the microphone 1911 is fed to a coder/decoder (CODEC) 1913.

A radio section 1915 amplifies power and converts frequency in order to communicate with a base station, which is included in a mobile communication system, via antenna 1917. The power amplifier (PA) 1919 and the transmitter/modulation circuitry are operationally responsive to the MCU 1903, with an output from the PA 1919 coupled to the duplexer 1921 or circulator or antenna switch, as known in the art. The PA 1919 also couples to a battery interface and power control unit 1920.

In use, a user of mobile station 1901 speaks into the microphone 1911 and his or her voice along with any detected background noise is converted into an analog voltage. The analog voltage is then converted into a digital signal through the Analog to Digital Converter (ADC) 1923. The control unit 1903 routes the digital signal into the DSP 1905 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1925 for compensation of any frequency-dependent impairments that occur during transmission though the air such as phase and amplitude distortion. After equalizing the bit stream, the modulator 1927 combines the signal with a RF signal generated in the RF interface 1929. The modulator 1927 generates a sine wave by way of frequency or phase modulation. In order to prepare the signal for transmission, an up-converter 1931 combines the sine wave output from the modulator 1927 with another sine wave generated by a synthesizer 1933 to achieve the desired frequency of transmission. The signal is then sent through a PA 1919 to increase the signal to an appropriate power level. In practical systems, the PA 1919 acts as a variable gain amplifier whose gain is controlled by the DSP 1905 from information received from a network base station. The signal is then filtered within the duplexer 1921 and optionally sent to an antenna coupler 1935 to match impedances to provide maximum power transfer. Finally, the signal is transmitted via antenna 1917 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1901 are received via antenna 1917 and immediately amplified by a low noise amplifier (LNA) 1937. A down-converter 1939 lowers the carrier frequency while the demodulator 1941 strips away the RF leaving only a digital bit stream. The signal then goes through the equalizer 1925 and is processed by the DSP 1905. A Digital to Analog Converter (DAC) 1943 converts the signal and the resulting output is transmitted to the user through the speaker 1945, all under control of a Main Control Unit (MCU) 1903—which can be implemented as a Central Processing Unit (CPU) (not shown).

The MCU 1903 receives various signals including input signals from the keyboard 1947. The keyboard 1947 and/or the MCU 1903 in combination with other user input components (e.g., the microphone 1911) comprise a user interface circuitry for managing user input. The MCU 1903 runs a user interface software to facilitate user control of at least some functions of the mobile station 1901 to match a candidate user to an institution based on athletic performance information, athletic observation information, and selection criteria. The MCU 1903 also delivers a display command and a switch command to the display 1907 and to the speech output switching controller, respectively. Further, the MCU 1903 exchanges information with the DSP 1905 and can access an optionally incorporated SIM card 1949 and a memory 1951. In addition, the MCU 1903 executes various control functions required of the station. The DSP 1905 may, depending upon the implementation, perform any of a variety of conventional digital processing functions on the voice signals. Additionally, DSP 1905 determines the background noise level of the local environment from the signals detected by microphone 1911 and sets the gain of microphone 1911 to a level selected to compensate for the natural tendency of the user of the mobile station 1901.

The CODEC 1913 includes the ADC 1923 and DAC 1943. The memory 1951 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1951 may be, but not limited to, a single memory, CD, DVD, ROM, RAM, EEPROM, optical storage, or any other non-volatile or non-transitory storage medium capable of storing digital data.

An optionally incorporated SIM card 1949 carries, for instance, important information, such as the cellular phone number, the carrier supplying service, subscription details, and security information. The SIM card 1949 serves primarily to identify the mobile station 1901 on a radio network. The card 1949 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a first data set from a first device associated with a candidate user, wherein the first data set includes athletic performance information;
receiving a second data set from a second device associated with a coaching user, wherein the second data set includes athletic observation information associated with the candidate user;
determining selection criteria associated with a plurality of institutions for a sports program;
matching the candidate user with one or more of the plurality of institutions based on the first data set, the second data set, and the determined selection criteria; and
initiating presentation of the one or more matching institutions to the first device.

2. The method of claim 1, wherein the candidate user is among a plurality of candidate users, and the coaching user is among a plurality of coaching users, the method further comprising:
registering the plurality of candidate users and the plurality of coaching users as part of a subscription service.

3. The method of 1, wherein the matching further comprising:
comparing the first data set and the second data set associated with the plurality of candidate users;
ranking the plurality of candidate users based on the comparison;
ranking the plurality of institutions based on the selection criteria; and
calculating a probability of acceptance of the candidate user by at least one institution from the plurality of institutions based on the rankings.

4. The method of 1, further comprising:
determining compatibility level between the candidate user and the coaching user based on the first data set and the second data set; and
matching the candidate user and the coaching user based on the compatibility level.

5. The method of 1, wherein the athletic performance information comprises athletic performance test result of an overall athletic performance of the candidate user.

6. The method of 1, wherein the athletic observation information comprises attributes of the candidate user, preferences of the candidate user concerning attributes of the coaching user, preferences of the candidate user concerning attributes of the plurality of institutions, or a combination thereof.

7. The method of 1, further comprising:
determining location information of the candidate user; and
determining the coaching user, the plurality of institutions, or a combination thereof based on proximity to the location information.

8. A system comprising:
one or more servers configured to perform:
receiving a first data set from a first device associated with a candidate user, wherein the first data set includes athletic performance information;
receiving a second data set from a second device associated with a coaching user, wherein the second data set includes athletic observation information associated with the candidate user;
determining selection criteria associated with a plurality of institutions for a sports program;
matching the candidate user with one or more of the plurality of institutions based on the first data set, the second data set, and the determined selection criteria; and
initiating presentation of the one or more matching institutions to the first device.

9. The system of claim 8, wherein the candidate user is among a plurality of candidate users, and the coaching user is among a plurality of coaching users, the one or more servers being further configured to perform:
registering the plurality of candidate users and the plurality of coaching users as part of a subscription service.

10. The system of claim 8, wherein the one or more servers are further configured to perform:
comparing the first data set and the second data set associated with the plurality of candidate users;
ranking the plurality of candidate users based on the comparison;
ranking the plurality of institutions based on the selection criteria; and
calculating a probability of acceptance of the candidate user by at least one institution from the plurality of institutions based on the rankings.

11. The system of claim 8, wherein the one or more servers are further configured to perform:
determining compatibility level between the candidate user and the coaching user based on the first data set and the second data set; and
matching the candidate user and the coaching user based on the compatibility level.

12. The system of claim 8, wherein the athletic performance information comprises athletic performance test result of an overall athletic performance of the candidate user.

13. The system of claim 8, wherein the athletic observation information comprises attributes of the candidate user, preferences of the candidate user concerning attributes of the coaching user, preferences of the candidate user concerning attributes of the plurality of institutions, or a combination thereof.

14. The system of claim 8, wherein the one or more servers are further configured to perform:
determining location information of the candidate user; and
determining the coaching user, the plurality of institutions, or a combination thereof based on proximity to the location information.

15. A method comprising:
inputting, via a graphical user interface of a device, athletic performance information for a user registered with a service platform for sports program matching;
initiating transmission of the athletic performance information to the service platform;
receiving institution information specifying one or more institutions that are compatible with the athletic performance information; and
displaying, via the graphical user interface, the institution information, wherein the graphical user interface includes,
a first section for presenting icons representing the one or more institutions, and
a second section for presenting menus, buttons, and data entry fields representing general information pertaining to the one or more institutions.

16. The method of claim 15, wherein the icons comprise web page icons of the one or more institutions further comprising:
detecting an activation of one of the web page icons based on a touch-based user input; and
displaying, via the graphical user interface, a web page that corresponds to the activated web page icon.

17. The method of claim 15, wherein the icons comprise a chart icon further comprising:
detecting an activation of the chart icon based on a touch-based user input; and
displaying, via the graphical user interface, a chart that represent a ranking of the one or more institutions, wherein the ranking is based on selection criteria associated with sports programs of the one or more institutions.

18. The method of claim 15, further comprising:
detecting a selection of the icons, the buttons, the menus, and the data entry fields; and
modifying appearance of the icons, the buttons, the menus, and the data entry fields,
wherein modifying the appearance of the icons comprises changing color, shape, size, or a combination thereof of the icons, the buttons, the menus, and the data entry fields.

19. The method of claim 15, wherein positioning of the icons, the buttons, and the data entry fields in the graphical user interface is based on metadata, user inputs, or a combination thereof.

20. The method of claim 15, wherein the general information comprises names of the one or more institutions, locations of the one or more institutions, sports programs in the one or more institutions, academic programs in the one or more institutions, and scholarship information for the academic programs.
